(19) United States
(12) Patent Application Publication
(10) Pub. No.: US 2013/0191185 A1
(43) Pub. Date: Jul. 25, 2013

(54) SYSTEM AND METHOD FOR CONDUCTING REAL-TIME AND HISTORICAL ANALYSIS OF COMPLEX CUSTOMER CARE PROCESSES

(71) Applicant: Brian R. Galvin, Seabeck, WA (US)

(72) Inventor: Brian R. Galvin, Seabeck, WA (US)

(21) Appl. No.: 13/357,502

(22) Filed: Jan. 24, 2012

(51) Int. Cl. G06Q 10/06

(52) U.S. Cl. 705/7.37; 705/7.36

(57) ABSTRACT

A system for conducting real-time and historical analysis of complex customer care processes, comprising an event collector software module, a complex event processing software module adapted to receive events from the event collector software module, a distributed data storage layer, a business analytics software module adapted to receive and process data from the distributed data storage layer, a distributed configuration software module, and a user interface software module adapted to receive analytics results from the business analytics software module.

Upon receiving an event from an event source, the event collector software module at least converts the event into a standard event data format suitable for use by the complex event processing software module and extracts or masks sensitive data from the event based on privacy rules maintained by the distributed configuration software module.

### CROSS-REFERENCE TO RELATED APPLICATIONS

None.

### BACKGROUND OF THE INVENTION

1. Field of the Invention

The invention relates to the field of data analytics, and particularly to the field of automated analysis of complex customer care processes.

2. Discussion of the State of the Art

In the last forty years, “customer care” using remote call or contact centers (that is, remote from the perspective of the customer being cared for, as opposed to in-person customer care at, for example, a retail establishment, which is clearly not remote) has become a major activity of large corporations. Various estimates indicate that somewhere between 2 and 5 million people in the United States alone currently work on call or contact centers (in the art, “call center” generally refers to a center that handles only phone calls, while “contact center” refers to a center that handles not only calls but also other customer communication channels, such as electronic mail (“email”), instant messaging (“IM”), short message service (“SMS”), chat, web sessions, and so forth; in this document, applicant will generally use the term “contact center”, which should be understood to mean either call centers or contact centers, as just defined).

Contact centers are home to some of the more complex business processes engaged in by enterprises, since the process is typically carried out not only by employees or agents of the enterprise “running” the contact center, but also by the customers of the enterprise. Since an enterprise's customers will generally have goals that are different from, and often competitive with, the goals of the enterprise, and since customer care personnel (contact center “agents”) will often also have their own goals or preferences that may not always match those of the enterprise, the fact is that contact center processes lie somewhere between collaborative processes and purely competitive processes (like a courtroom trial). The existence of multiple competing or at least non-aligned stakeholders jointly carrying out a process means that, even when great effort is expended to design an efficient process, what actually occurs is usually a dynamic, surprising, and intrinsically complex mix of good and bad sub-processes, many of which occur without the direction or even knowledge of an enterprise's customer care management team.

Despite the complexity of contact center operations, it is a matter of significant economic importance to try to improve both the productivity of contact centers (from the enterprise's perspective) and the quality of the experience of the customers they serve. Accordingly, considerable effort has been applied in the art to provide platforms, applications, tools, and techniques for measuring performance of modern contact centers. For example, FIG. 1 illustrates an exemplary prior art architecture designed to support reporting and analytics for a multisite contact center of an enterprise. In the example, an enterprise operates two contact center sites, one of which 100 is a multichannel contact center (that is, one that serves customers who interact via more than one communications channel), while the second site 101 is an exclusively voice-based operation (that is, all interactions with customers are via phone calls; this is what has been referred to in the art historically as a “call center”).

Considering first voice-only site 101, calls from consumers can arrive from many sources, including ordinary telephones 160, mobile phones 161, and VoIP telephones 168. In some cases, telephone calls are delivered from public switched telephone network (PSTN) 110 to an automated call distribution system (ACD 116), while in other cases calls from PSTN 110 are delivered to, for example, a session initiation protocol (SIP) server 123 via an internet protocol (IP) connection. It is well-known in the art to deliver “plain old telephone service” (POTS) phone calls via one of a time-division multiplexing (TDM) circuit, an integrated services digital network (ISDN) circuit, or via IP either through IP or SIP trunking (connecting directly from PSTN 110 to SIP server 123) or over an Internet 111 using one of many standard protocols well-known in the art, including SIP. For purposes of illustration, only a SIP server 123 is shown in center 101, but other protocol-specific media servers such as an H.323 server are used as well in the art.

In typical voice-only sites 101, control signals are delivered from either SIP server 123 or ACD 116, or both, to CTI server 121 (“CTI” means computer-telephony integration). In general, control signals comprise a mix of notification messages pertaining to events that have occurred (for example, “EventCallQueued” when a call is queued at ACD 116 or SIP server 123, or “EventCallEstablished” when ACD 116 or SIP server 123 detects that a call has been established to an endpoint such as agent phone 139), and requests to take action (for example, “RequestReleaseCall” to ask ACD 116 to release a call at an agent phone 139, generally, requests are sent to the servers and carried out there, and events are sent to the servers' clients and responded to there. “Responding to an event” could be, for example, displaying a screen of data relevant to a particular caller on agent computer 130 when an “EventCallEstablished” event is received from either ACD 116 or SIP server 123. Generally, events are delivered with several fields of relevant information pertaining to the call itself and one or more parties associated with the call, including but not limited to the calling party's phone number, a number they dialed, menu choices they might have made in an interactive voice response system (not shown, but commonly associated with ACD 116 or SIP servers 123), and so forth.

In many cases in the art, CTI server 121, on receiving an event from a switch (the term “switch” refers to either ACD 116, SIP server 123, or any other switching system associated with a contact center), executes a query via CRM server 137 to gather data pertaining to one or more parties present on the call. Data is gathered by CRM Server 137, usually but not necessarily exclusively from a CRM database 138; the task of identifying relevant data is usually simplified by passing a customer phone number or account number (which may have been included in the event data received by CTI server 121) to CRM server 137. As a call progresses, it is often routed or delivered from a queue or a route point on a switch to an agent phone 139. As mentioned briefly above, CTI server 121 usually sends data pertaining to the call and any parties to the call to the agent who receives the call (CTI server 121 “knows” which agent because ACD 116 or SIP server 123 usually sends an event such as “EventCallDiverted” to CTI server 121 advising it that a given call is being delivered or offered to agent phone 139 associated with a particular agent computer 130—and of course with a specific human agent, or customer service professional—and CTI server 121 extracts the necessary information from the event) in order to trigger the “screen pop”.

Considering now multimedia-capable contact center 100, which for simplicity is shown with only one voice channel, an interaction server 122 is added to the mix. Interaction server is used typically in a role analogous to voice switches (ACD 115, 116 and SIP server 123); that is, interaction server 122 manages routing, event handling, delivery, and tracking of non-voice interactions. Non-voice interactions can come from many sources and in many media types. For example, in the art it is common for non-voice interactions to be initiated or received by consumers via one or more of email 165, a web browser 166, a chat or instant messaging (“IM”) client software 167, or short message server (“SMS”) client 162. These interaction sources reside on any of a number of computing or communicating devices; for instance, SMS 162 is normally sent and received from a mobile phone but can also be sent from general-purpose computers, while email 165 is a now well-established means of communicating using essentially any compute-enabled device, whether a supercomputer, desktop workstation computer, laptop computer, tablet device, mobile or smart phone, gaming console, or even a television. While SMS is generally delivered by a PSTN 110, it is possible within the art to send SMS over the Internet (not shown), and in general all of the non-voice interaction types are suitable for transmission over essentially any packet-based networking system, whether a PSTN 110, an Internet 111, or some sort of corporate or other private network (not shown).

Since most non-voice interaction types (that is, email, SMS, chat, IM, web sessions, etc.) are not as critically dependent on synchronous, circuit-like connections between endpoints, and since they often require persistence (for example, when an email 165 is sent by customers to a contact center, the customers will generally go about their business normally, not expecting an instant response), non-voice interactions are generally stored in an interaction database 125. By contrast, phone calls, whether TDM or IP-based, generally are connected to a switch and maintained until one or more parties ‘hangs up”, at which point the “circuit” is torn down (often these circuits are “virtual circuits”, where a stream of packets is treated as if it were a dedicated circuit from one party to the other). As mentioned above, interaction server 122 acts as a switch for non-voice interactions, and accordingly it handles functions such as prioritizing, routing, delivering, and suspending (analogous to holding a call) non-voice interactions, sending them at appropriate times to one or more agent computers 130 for handling.

In contact centers, whether multichannel or strictly voice-based, reporting on and analysis of ongoing operations is a fundamentally important activity. Referring again to FIG. 1, data is collected, generally in the form of a stream of predefined events, by either an interaction concentrator 135 or a call concentrator 136 (both terms are used in the art, the main relevant distinction being that the former handles interactions of all types and the latter handles only “calls”, which generally means voice calls but can sometimes extend to include synchronous IM sessions). Interaction concentrator 135 and call concentrator 136 each take events they receive, apply fixed call recognition of interaction recognition logic to them, and write out detailed information about the call or interaction to an operational data store 140, 141. The operational data store usually contains one record, or line of data, for each call or interaction completed, with each record having generally a unique call or interaction identifier, a start and possibly an end time of the call (“call” should be understood herein to always refer to either a voice call or an interaction in some other medium, unless expressly limited to voice calls by the immediately surrounding text), and various statistical information about the call, such as how long it took (since end times are not always provided), how long it spent in a held state, how long it spent in a queue before being answered by an agent, whether or not it went to an IVR (and if so, what data was collected there). Other data commonly present in call detail records stored in an operational data store 140, 141 are data elements pertaining to the media-specific details of the call, such as the number from which the call originated, a call type (for example, internal, inbound from outside a center, or outbound to someone outside a center), extension numbers for each agent or other extension to which the call was delivered and at which it was handled (and often subsidiary statistics are provided pertaining to how long the call spent on each extension, how long it was held there, and so forth). Finally, in many systems known in the art it is common for business-related data associated with the call, generally obtained from agent computer 130 or from CRM server 137, although it is possible to collect call-related data from any appropriate data source; such data may include one or more skills required in handling the call, a call business reason (sales, service, technical support, credit issue, collections, etc.), customer name, reason for the call as stated by the customer, agent notes about the call, and so forth. Such business data that is not generated automatically by CTI server 120, 121 or interaction server 122 is commonly known as “attached data” or “call data”, and is often stored with predefined data elements in operational data store 140, 141.

In systems known in the art, data collected by operational data stores 140, 141 is periodically extracted from them, transformed into a more useful form, and loaded into a datamart (while this is a common name for business intelligence, or “BI”, oriented databases optimized for reporting and analytics, other names are used in the art, including infomart, data warehouse, and so forth). Extraction, transformation, and loading process is known as an ETL process 145, and often runs on its own dedicated server computer (although this is not always true). After ETL engine 145 populates datamart 150 with relevant data in a form that is optimized for reporting and analytics, the data is typically accessed via a BI application 155. BI applications 155 typically allow standard reports to be designed, generally by a specially-qualified BI specialist, and it also typically allows ad hoc analysis by business analysts. Such business analysts generally interact via browsers 156 with BI application 155, although there are many instances of purpose-built analytical applications that run outside of a browser 156. Data from BI application 155 is generally made available to business consumers in a variety of forms, including dashboards 157 used to monitor business operations, real-time monitors 159 that monitor specific data elements and trends relating to them, often triggering alarms or sending alert messages when predefined thresholds are exceeded.

The detailed discussion just provided of a typical contact center information ecosystem represents the current state of the art. There are many variations, and many different combinations of functionality that are available in the marketplace, but most ultimately can be recast in a form similar to that shown in FIG. 1. Systems such as that shown in FIG. 1 are effective at providing reports and basic analytical tools for monitoring and analyzing contact center operations, but they have several important shortcomings. First, all systems in the art and known to the inventor are based on fixed state models. That is, generally a component such as call concentrator 136 is designed and coded to handle phone calls, and many assumptions about the types of phone calls are built into the component. Generally, when a new call-related capability is introduced, such as scheduled call-back features, the new feature must operate without any reporting at first, and then later it generally is the case that custom data elements are created outside of the existing call concentrator for collecting data pertaining to the new feature. Generally it may take years before standard reporting systems are redesigned to comprehend the unanticipated call model (a call model, or analogously an interaction model, is a sequence of events representing a particular kind of call, or interaction, as it progresses through contact centers 100, 101). This “hard-wired” nature of contact center analytics, which is very much the state of the art today, poses real challenges because of the rapid rate of introduction of new communications means and their ready adoption by consumers. For example, the explosive growth of social network systems in the last five years has resulted in new use cases within contact centers that were never contemplated, and the existing reporting infrastructure is incapable of handling these new use cases. Simply put, interactions in a social network are not “calls” as traditionally understood, and they are more rich in their phenomenology than instant messages, chat sessions, or emails. The hard-coded event sequences expected by call concentrator 138 and interaction concentrator 135 simply are unable to make sense of a stream of events from a social network server; moreover, they are generally incapable of even getting these events, since they do not normally pass through or interact with ACD 115, 116, interaction server 122, or SIP server 123. Thus, when businesses adopt new means of interacting with their customers, and more importantly when consumers adopt new means of interacting with each other—where they may well interact for the purpose of telling others about an experience with a given enterprise—they usually have to “fly blind” because their existing reporting and analytics infrastructure does not provide any support for the new means.

Another problem with contact center reporting and analytics solutions currently known in the art is that they generally are limited to reporting and analyzing only single interactions, although they may be complex (for instance, if a call arrives, is queued, goes to an agent, is held there while a consultative call is made to an expert agent, then is retrieved and completed, both the original call and the consultative call are understood to be part of one “compound call” and are generally reported as such). If a customer, while active on a company's web site, decides to initiate a chat session with an agent, gets part of what is needed, then leaves the chat session and the web site, only to follow up an hour later with a phone call to finish the inquiry, all current reporting systems see two or perhaps three separate and unrelated interactions (the web session, the chat session, and the later phone call). Very few systems are able to comprehend this sequence as a single “service chain” or “extended interaction” and to provide a full reporting and analytics capability to understand such interactions.

Yet another problem in the art is that systems known in the art generally reduce the information content that is available in a comprehensive event stream into a seemingly more-manageable form, principally in the form of predefined statistical data. Each call detail record in operational data stores 140, 141 contains data about a call that is reasonably good for answering questions or providing reports that have been anticipated and designed in; by contrast, though, if it becomes clear from experience that some new metric of phenomenology needs to be measured that wasn't considered when the data schema was originally set up, it will be immeasurable until the operational data store is upgraded (a process that typically takes months and is expensive to carry out). Thus, unless a new question can be answered with some combination of the predefined statistics (including aggregations of the predefined statistics, which is generally easy to accomplish after the fact, in the art), the question will not be answerable until after an expensive and lengthy redesign has taken place. Since the value of a new question may not be clear until after it has been asked and the results of asking it considered, such novel questions are rarely asked and answered because the investment needed to make them answerable can rarely be justified in advance with any certainty.

Another serious problem with the current art is that systems such as those shown in FIG. 1 are very expensive to deploy, maintain, and integrate with existing systems. Accordingly, many enterprises are moving to some form of adoption of cloud-based services in an effort to eliminate costs and to add some amount of flexibility. However, the above-mentioned problems are exacerbated in typical cloud deployments, since one of the ways cloud providers keep costs to a minimum is by offering “out of the box” functionality to everyone at a price point that is hard to resist. However, since contact centers are intrinsically very complex systems (as discussed above), it is extremely unlikely that meaningful insights into how the complex system is working, or even more importantly how to optimize its functioning, will be obtainable from the simplified, “one size fits all” reporting infrastructures that are typical of current cloud-based contact center solutions. In addition, serious security concerns usually arise when enterprises consider cloud-based software solutions, and these concerns tend to be amplified in contact center deployments because of the central role that customer-specific data plays in contact center operations. Ensuring compliance with rapidly-evolving consumer protection and data privacy laws, which vary greatly between jurisdictions and often apply even to very small enterprises is beyond what most cloud providers can do, so enterprises generally take a very cautious approach to sourcing any but the most benign, and simple, calls to the cloud.

What is needed is a system for providing rich, deep analytics capabilities for contact center operations in the cloud, while ensuring an extremely high degree of operational and technical flexibility, a robust security model, and the ability to provide a platform supportive of rapid analytical development—particularly enabling the development of new analyses or tools which can be used against previously collected data (implying the need for an essentially lossless data collection infrastructure in the cloud).

### SUMMARY OF THE INVENTION

Accordingly, the inventor has conceived and reduced to practice, in a preferred embodiment of the invention, a system for conducting real-time and historical analysis of complex customer care processes, comprising an event collector software module, a complex event processing software module adapted to receive events from the event collector software module, a distributed data storage layer, a business analytics software module adapted to receive and process data from the distributed data storage layer, a distributed configuration software module, and a user interface software module adapted to receive analytics results from the business analytics software module. Upon receiving an event from an event source, the event collector software module at least converts the event into a standard event data format suitable for use by the complex event processing software module and extracts or masks sensitive data from the event based on privacy rules maintained by the distributed configuration software module.

According to another embodiment of the invention, the event collector further comprises at least an interface adapted to receive events delivered via a packet-based data network and a module for converting events from a first event data protocol into a second event data protocol. According to a further embodiment, the processing of the event is carried out at least in part based on an event-processing rule maintained by the distributed configuration software module. In some preferred embodiments, the complex event processing software module maintains a state machine for each object for which events may be received from the event collector and, upon receiving an event from the event collector, the complex event processing software module changes the state machine for objects affected by the event based on the event.

In yet a further embodiment of the invention, the business analytics software module is a business intelligence platform comprising at least a module for extraction, transformation, and loading of data from the distributed data storage layer, a datamart, a query interface, and an application server adapted to wirelessly receive query requests from a plurality of tablet-based user interface devices. In another embodiment, the business analytics software module further comprises a plurality of machine learning modules adapted to generate actionable recommendations based on automated analysis of data in the distributed data storage system. In yet another embodiment, the business analytics software module is a simulation software module coupled to and controlled by a simulation manager user interface, and the simulation software module performs a simulation of the operation of a real system, the real system being at least one of the sources of the events received by the event collector. In yet a further embodiment of the invention, upon performance of a simulation of the operation of the real system, simulated events generated by the simulation are passed to the complex event processing software module. In yet a further embodiment of the invention, the business analytics software module is an optimization engine software module coupled to and controlled by an optimization manager user interface. According to the embodiment, the optimization engine module performs at least one optimization computation based on data derived at least in part from a plurality of events received by the event collector, and at least one operational parameter used by a system from which events were received by the event collector is adjusted based on the at least one optimization computation.

According to another preferred embodiment of the invention, a method for conducting real-time and historical analysis of complex customer care processes is disclosed. The method comprises the steps of (a) receiving a plurality of events at an event collector software module; (b) transforming the event from a format in which it was received into a second event format; (c) receiving events in the second event format from the event collector at a complex event processing layer; (d) updating a state machine in the complex event processing software module for each object that is affected by the event, the updating based on the event; (e) when appropriate based on the event received, passing state model events or metaevents from the complex event processing software module to a distributed data storage layer, the state model events based on changes in the state machines of the affected objects and the metaevents based on one or more previously received events or the received event; and (f) using the state model events and metaevents in a business analytics software module.

In another embodiment of the invention, the method further comprises the step of (b1) extracting or masking sensitive data from the plurality of events according to privacy rules maintained by a configuration subsystem. In a further embodiment of the invention, the business analytics software module is a business intelligence platform comprising at least a module for extraction, transformation, and loading of data from the distributed data storage layer, a datamart, a query interface, and an application server adapted to wirelessly receive query requests from a plurality of tablet-based user interface devices. In yet a further embodiment of the invention, the business analytics software module further comprises a plurality of machine learning modules adapted to generate actionable recommendations based on automated analysis of data in the distributed data storage system. In another further embodiment, the business analytics software module is a simulation software module coupled to and controlled by a simulation manager user interface, and the method further comprises the step of (g) performing a simulation of the operation of a real system, the real system being at least one of the sources of the events received by the event collector. In yet a further embodiment of the invention, the method further comprises the step of (h) passing simulated events generated by the simulation to the complex event processing software module.

According to another embodiment of the invention, the business analytics software module is an optimization engine software module coupled to and controlled by an optimization manager user interface, and the method further comprises the steps of (g) performing at least one optimization computation based on data derived at least in part from a plurality of events received by the event collector; and (h) adjusting at least one operational parameter used by a system from which events were received by the event collector based on the at least one optimization computation.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 (PRIOR ART) is a block diagram of a contact center reporting and analytics system according to the art.

FIG. 2 is an architecture diagram of a preferred embodiment of the invention.

FIG. 3 is a process flow diagram of a process for event collection according to an embodiment of the invention.

FIG. 4 is a block diagram illustrating a complex event processing layer, according to an embodiment of the invention.

FIG. 5 is a process flow diagram illustrating a process for complex event processing, according to an embodiment of the invention.

FIG. 6 is an illustrative pair of state charts illustrating relationships between states, objects, and events, according to an embodiment of the invention.

FIG. 7 is a process flow diagram illustrating a process for managing a flexible state machine, according to an embodiment of the invention.

FIG. 8 is a process flow diagram illustrating a process for managing a flexible state machine using dynamic state models, according to an embodiment of the invention.

FIG. 9 is an illustration of a data model suitable for path analytics, according to an embodiment of the invention.

FIG. 10 is a block diagram of an embodiment of the invention, highlighting aspects of a business intelligence stack.

FIG. 11 is a block diagram of an embodiment of the invention, highlighting aspects of a machine learning stack.

FIG. 12 is a block diagram of an embodiment of the invention, highlighting aspects of a simulation stack with dynamic simulation model development.

FIG. 13 is a process flow diagram illustrating a process according to an embodiment of the invention in which machine learning is used to adapt a complex customer care process.

FIG. 14 is a block diagram of an embodiment of the invention, highlighting aspects of an optimization stack.

FIG. 15 is a process flow diagram illustrating a process according to an embodiment of the invention in which an optimization stack is used to optimize a complex customer care process.

FIG. 16 is a block diagram illustrating an exemplary hardware architecture of a computing device used in an embodiment of the invention.

FIG. 17 is a block diagram illustrating an exemplary logical architecture for a client device, according to an embodiment of the invention.

FIG. 18 is a block diagram showing an exemplary architectural arrangement of clients, servers, and external services, according to an embodiment of the invention.

### DETAILED DESCRIPTION

The inventor has conceived, and reduced to practice, a cloud-based deep analytics platform that addresses the several shortcomings, described in the background section, of current systems in the art. Systems deployed in accordance with one or more embodiments of the invention will generally be easily extensible to handle new data sources, new call models, new interaction types, and series of multiple related interactions, all while providing a very strong answer to enterprise's security concerns.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified other wise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Furthermore, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of the embodiments of the present invention in which for example functions may be executed out of order from that shown or discussed, including substantially concurrently or in reverse order, depending on the functionality involved, as would be understood by those having ordinary skill in the art.

### DEFINITIONS

An “event” is a data representation of an instantaneous occurrence. For example, an event may be a data object or structure that comprises a set of data elements appropriate to describe an occurrence such as the arrival of a telephone call at a destination station. Such an event might include, for example, a time of arrival, a source of the call, an identity of the destination station at which the call arrived, an identity of the event as representing an occurrence of type of “call arrival”, and possibly other fields such as an identity of the caller.

A “complex event processor” or a “complex event processing layer” is a component typically (but not necessarily) rendered in software that enables one to predict high-level results or occurrences (sometimes referred to as metaevents) likely to result from specific sets of low-level events. A complex event processor identifies and analyzes cause-and-effect relationships among events in real time, allowing it to proactively take or recommend effective actions in response to specific scenarios. Complex event processors generally operate by executing queries in a language similar to the well-known Structured Query Language (SQL), but adapted for handling streams of real time events, and these queries are executed against streams of events arriving at the complex event processor, generally from a plurality of event sources.

A “state machine” or a “state engine” is a component, either in software or in hardware (e.g., in a custom semiconductor device) that stores the state or status of one or more objects at a given time and that can operate on input (e.g., events) to change the state or status of one or more objects based on events or inputs received, and can also cause one or more actions or outputs to occur as a result of one or more state changes or events.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, or on a network interface card. In a specific embodiment, the techniques disclosed herein may be implemented in software such as an operating system or in an application running on an operating system.

Software/hardware hybrid implementation(s) of at least some of the embodiment(s) disclosed herein may be implemented on a programmable machine selectively activated or reconfigured by a computer program stored in memory. Such network devices may have multiple network interfaces that may be configured or designed to utilize different types of network communication protocols. A general architecture for some of these machines may appear from the descriptions disclosed herein. According to specific embodiments, at least some of the features and/or functionalities of the various embodiments disclosed herein may be implemented on one or more general-purpose network host machines such as an end-user computer system, computer, network server or server system, mobile computing device (e.g., personal digital assistant, mobile phone, smartphone, laptop, tablet computer, or the like), consumer electronic device, music player, or any other suitable electronic device, router, switch, or the like, or any combination thereof. In at least some embodiments, at least some of the features and/or functionalities of the various embodiments disclosed herein may be implemented in one or more virtualized computing environments (e.g., network computing clouds, or the like).

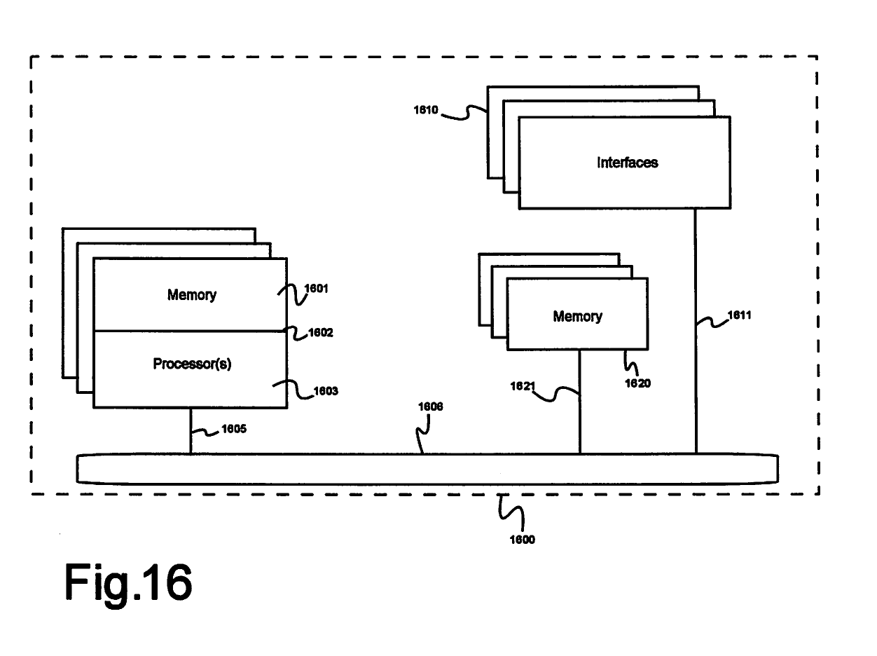

Referring now to FIG. 16, there is shown a block diagram depicting a computing device 1600 suitable for implementing at least a portion of the features and/or functionalities disclosed herein. Computing device 1600 may be, for example, an end-user computer system, network server or server system, mobile computing device (e.g., personal digital assistant, mobile phone, smartphone, laptop, tablet computer, or the like), consumer electronic device, music player, or any other suitable electronic device, or any combination or portion thereof. Computing device 1600 may be adapted to communicate with other computing devices, such as clients and/or servers, over a communications network such as the Internet, using known protocols for such communication, whether wireless or wired.

In one embodiment, computing device 1600 includes central processing unit (CPU) 1602, interfaces 1610, and a bus 1606 (such as a peripheral component interconnect (PCI) bus). When acting under the control of appropriate software or firmware, CPU 1602 may be responsible for implementing specific functions associated with the functions of a specifically configured computing device or machine. For example, in at least one embodiment, a user's [[[personal digital assistant (PDA) may be configured or designed to function as an intelligent automated assistant]]] system utilizing CPU 1602, memory 1601, 1620, and interface(s) 1610. In at least one embodiment, CPU 1602 may be caused to perform one or more of the different types of functions and/or operations under the control of software modules/components, which for example, may include an operating system and any appropriate applications software, drivers, and the like.

CPU 1602 may include one or more processor(s) 1603 such as, for example, a processor from one of the Intel, ARM, Qualcomm, and AMD families of microprocessors. In some embodiments, processor(s) 1603 may include specially designed hardware (e.g., application-specific integrated circuits (ASICs), electrically erasable programmable read-only memories (EEPROMs), field-programmable gate arrays (FPGAs), and the like) for controlling operations of computing device 1600. In a specific embodiment, a memory 1601 (such as non-volatile random access memory (RAM) and/or read-only memory (ROM)) also forms part of CPU 1602. However, there are many different ways in which memory may be coupled to the system. Memory block 1601 may be used for a variety of purposes such as, for example, caching and/or storing data, programming instructions, and the like.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 1610 are provided as interface cards (sometimes referred to as “line cards”). Generally, they control the sending and receiving of data packets over a computing network and sometimes support other peripherals used with computing device 1600. Among the interfaces that may be provided are Ethernet interfaces, frame relay interfaces, cable interfaces, DSL interfaces, token ring interfaces, and the like. In addition, various types of interfaces may be provided such as, for example, universal serial bus (USB), Serial, Ethernet, Firewire™, PCI, parallel, radio frequency (RF), Bluetooth™, near-field communications (e.g., using near-field magnetics), 802.11 (WiFi), frame relay, TCP/IP, ISDN, fast Ethernet interfaces, Gigabit Ethernet interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 1610 may include ports appropriate for communication with appropriate media. In some cases, they may also include an independent processor and, in some in stances, volatile and/or non-volatile memory (e.g., RAM).

Although the system shown in FIG. 16 illustrates one specific architecture for a computing device 1600 for implementing the techniques of the invention(s) described herein, it is by no means the only device architecture on which at least a portion of the features and techniques described herein may be implemented. For example, architectures having one or any number of processors 1603 can be used, and such processors 1603 can be present in a single device or distributed among any number of devices. In one embodiment, a single processor 1603 handles communications as well as routing computations. In various embodiments, different types of features and/or functionalities may be implemented in a system according to the invention that includes a client device (such as a personal digital assistant or smartphone running client software) and server system(s) (such as a server system described in more detail below).

Regardless of network device configuration, the system of the present invention may employ one or more memories or memory modules (such as, for example, memory block 1620) configured to store data, program instructions for the general-purpose network operations and/or other information relating to the functionality of the embodiments described herein. The program instructions may control the operation of an operating system and/or one or more applications, for example. The memory or memories may also be configured to store data structures, domain and topic information, social network graph information, user actions information, and/or other specific non-program information described herein.

Because such information and program instructions may be employed to implement the systems/methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory, solid state drives, memristor memory, random access memory (RAM), and the like. Examples of program instructions include both machine code, such as produced by a compiler, and files containing higher level code that may be executed by the computer using an interpreter.

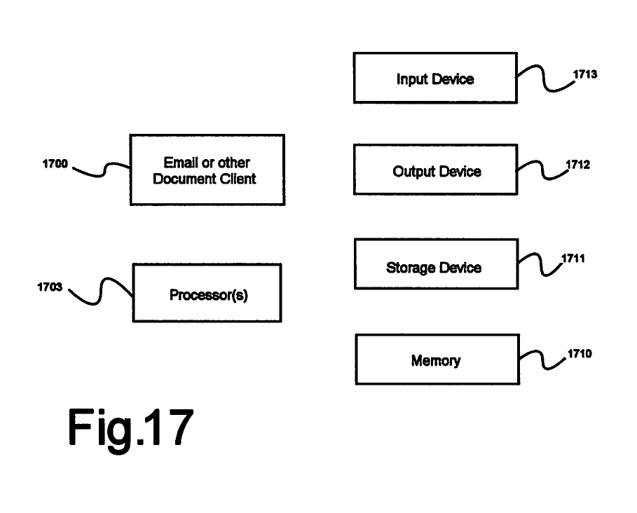

In some embodiment, systems used according to the present invention may be implemented on a standalone computing system. Referring now to FIG. 17, there is shown a block diagram depicting an architecture for implementing one or more embodiments or components thereof on a standalone computing system. Computing device 1600 includes processor(s) 1603 that run software for implementing for example an email or other document management client application 1700. Input device 1712 can be of any type suitable for receiving user input, including for example a keyboard, touchscreen, microphone (for example, for voice input), mouse, touchpad, trackball, five-way switch, joy stick, and/or any combination thereof. Output device 1711 can be a screen, speaker, printer, and/or any combination thereof. Memory 1710 can be random-access memory having a structure and architecture as are known in the art, for use by processor(s) 1603 for example to run software. Storage device 1711 can be any magnetic, optical, and/or electrical storage device for storage of data in digital form; examples include flash memory, magnetic hard drive, CD-ROM, and/or the like.

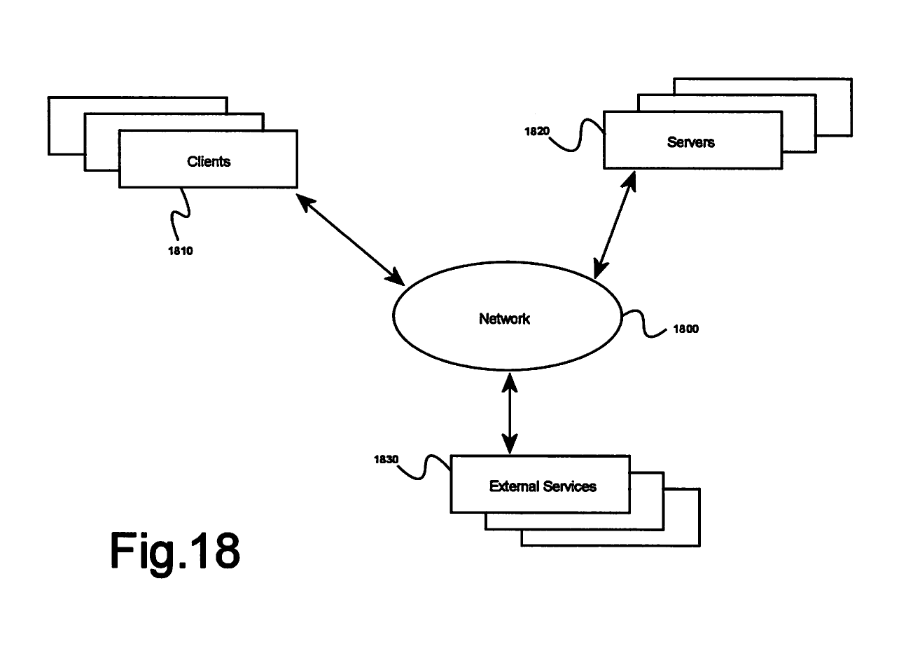

In some embodiments, the system of the present invention is implemented on a distributed computing network, such as one having any number of clients and/or servers. Referring now to FIG. 18, there is shown a block diagram depicting an architecture for implementing at least a portion of an intelligent automated assistant on a distributed computing network, according to at least one embodiment.

The arrangement shown in FIG. 18, any number of clients 1810 are provided; each client 1810 may run software for implementing client-side portions of the present invention. In addition, any number of servers 1820 can be provided for handling requests received from clients 1810. Clients 1810 and servers 1820 can communicate with one another via electronic network 1800, which may be in various embodiments any of the Internet, a wide area network, a mobile telephony network, a wireless network (such as WiFi, Wimax, and so forth), or a local area network (or indeed any network topology known in the art; the invention does not prefer any one network topology over any others). Network 1800 may be implemented using any known network protocols, including for example wired and/or wireless protocols.

In addition, in some embodiment, servers 1820 can call external services 1830 when needed to obtain additional information, to refer to additional data concerning a particular document or message, or to access for example curated data sources (for example, Wolfram Alpha™) in order to assist in building rich ontologies. Communications with external services 1830 can take place, for example, via network 1800. In various embodiments, external services 1830 include web-enabled services and/or functionality related to or installed on the hardware device itself. For example, in an embodiment where email client 1700 is implemented on a smartphone or other electronic device, client 1700 can obtain information stored in an email archive or a document store in the cloud or on an external service 1830 deployed on one or more of a particular enterprise's or user's premises.

In various embodiments, functionality for implementing the techniques of the present invention can be distributed among any number of client and/or server components. For example, various software modules can be implemented for performing various functions in connection with the pre sent invention, and such modules can be variously implemented to run on server and/or client components.

### Conceptual Architecture

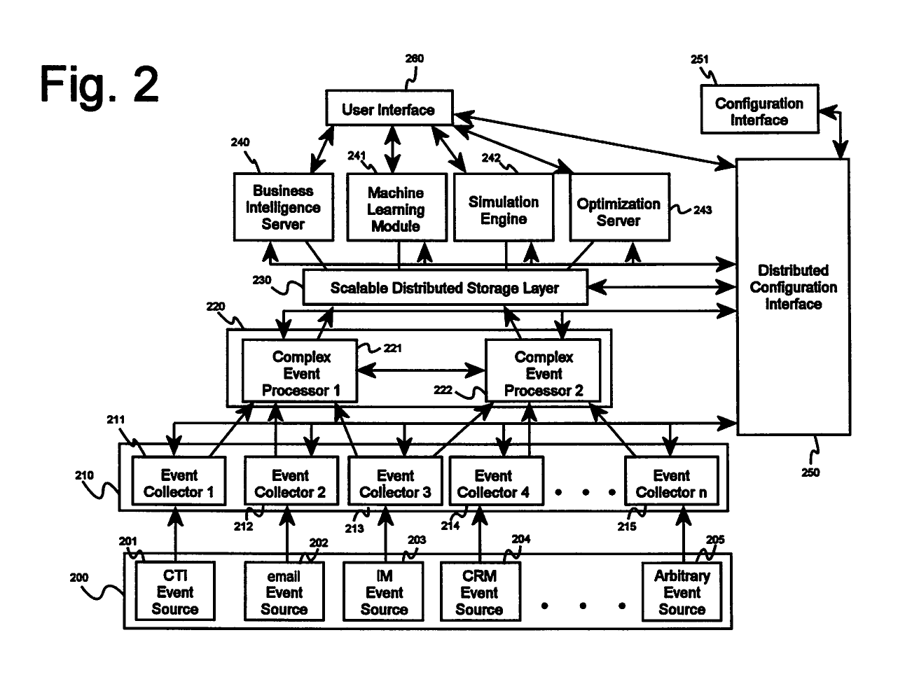

FIG. 2 provides a high-level diagram of a preferred embodiment of the invention, which will be useful for discussing aspects of the invention and improvements inherent in the invention over systems known in the art. According to the embodiment, events are received from a plurality of event sources 200 and transmitted to a plurality of event collectors 210. While many variations will be understood by one having ordinary skill in information systems architecture, in some embodiments event sources 200 will be located in, and managed by personnel of, a plurality of enterprises. Event sources 200 may include, but are not limited to, a CTI event source 201, an email event source 202, an IM event source 203, a CRM event source 204, and any number of arbitrary event sources 205. Typically, but not necessarily, CTI event source 201 will be a CTI server 120, 121 or a SIP server 123; similarly, other event sources generally correspond to one or more servers that manage interactions or data of the type specific to the event source. That is, email event source 202 is typically either an email server or an interaction server 125; IM event source 203 is typically either an IM server using a protocol such as Jabber, or again an interaction server 125; and a CRM event source is typically a CRM server 137.

Event collectors 210 generally are deployed on a one-to-one or one-to-few basis against event sources 200 whose event streams are to be monitored, and they are generally (but not necessarily) collocated with their respective event sources 200. Thus event collector 1 211 is a software module or a dedicated server that connects as a client to a CTI event source 201 (or subscribes to a CTI event source that implements a publish-and-subscribe service); event collector 2 212 is adapted to receive events from email event source 202, event collector 3 213 is adapted to receive events from IM event source 203, event collector 4 214 is adapted to receive events from a CRM event source 204, and in general event collector n 215 is adapted to receive events from an arbitrary event source 205. Each event collector 210 is adapted to connect to its applicable event source 200, using whatever protocol and authentication means are provided by the event source 200. For example, in one embodiment event collector 1 211 is a software module that connects to a Genesys T-Server (a specific CTI event source 201) using one of several Genesys-defined applications programming interfaces (APIs), and follows a normal Genesys approach by registering to receive events relating to each of the objects being monitored by that T-Server (a complete list of objects to be monitored can be obtained by further integrating to a Genesys configuration server—not shown—and requesting a list of all objects that are configured as being monitored by the specific T-Server). In some variants of the embodiment, event collector 1 211 connects to T-Server 201 and uses a special API call that says, in effect, “I don't have a list of objects, but I want to monitor all events”; in this variant, T-Server 201 merely sends a complete event stream to event collector 211 without checking whether the object to which a particular event is related is one that event collector 1 211 has subscribed to receive event notifications for.

It will be appreciated by one having ordinary skill in the art of enterprise software development that there are a wide range of techniques that can be used, or that are generally made available by event sources 200, by event collectors 210 to connect to specific event sources 200. Some examples include (although by no means is the invention limited to these examples), direct socket-level connection using APIs or protocols proprietary to one or a few event sources 200 (this is the case with the T-Server example just described), web services implementing a publish-and-subscribe interface pattern, emails (for example, email event source 202 can, in some embodiments, send events to events collector 2 212 by automatically transmitting emails to a specific address associated with event collector 2 212, each email containing data pertaining to one or more events occurring at email event source 212 (which, as mentioned above, is commonly a conventional email server), polling techniques common in the art, or even database triggers (for instance, triggers could be arranged in CRM database 138 to allow it to act as CRM event source 204 by writing rows of data (when CRM-specific data changes occur) to a special table for events, the table being queried by event collector 4 214 periodically.

A second key function of event collectors 200 is to transform events received from event sources 200 into a standard form that is common for all later stages in processing according to the invention. While events arriving at event collectors 200 are typically formatted in many different ways, and typically will have different data fields for each different event type (for example, events sent from an email event source 202 will typically contain slightly different data than events sent from an IM event source 203, and very different data from events sent from a CTI event source 201), in most embodiments of the invention a common protocol is used on the output side of event collectors 210. Selection of a particular protocol is not required according to the invention, although in preferred embodiments any such protocol for passing events from event collectors 210 to a complex event processing layer 220 will comprise at least an event identifier, an event time stamp, an interaction identifier (a unique identifier that corresponds to an interaction of which the event is a part), an event subject (an actor who “causes” or “executes” the action underlying the event), an optional event object (an actor or thing which is acted on by the event; of course there can be more than one object of an event), an event source identifier (it is generally important to know from which source an event came), and where applicable an event location (the location—whether physical, logical, or virtual—where the event in question “took place”). For example, if an event corresponds to the establishment of a call at a party's extension, it will likely contain at least the following data elements as it leaves the associated event source (in this case, CTI event source 201):
Event ID—a number uniquely identifying this event;
EventType—a number or a string, or sometimes both, corresponding to the type of event (in this example, “EventCallEstablished”);
InteractionID—a number uniquely identifying the interaction of which this event is part (that is, a number identifying the call which was established and thus gave rise to this event);
Extension—the extension or phone number where the call is established;
OtherExtension—the extension or phone number of the other party with whom the call was established;
EventTime—a time, often expressed in Universal Computer Time (UCT), which may or may not incorporate time zone adjustments;
EventLocation—a site identifier for the physical location where the extension at which the call was established resides;
AgentID—this is an identifier that corresponds to the person who is currently associated with Extension, and thus is in some sense the “event subject”; and
CustomerID—not always present, but represents a person outside an enterprise who is located at OtherExtension, and in this case would correspond to the “event object”.

Of course, there are any number of additional data fields that might be present in such an event, including but not limited to fields such as CallType (which could be inbound, outbound, internal, consultative, or possibly others), SkillRequired (a list of one or more call-handling skills required for handling this call), Language (the language of the caller, typically, which helps in ensuring selection of an agent who speaks the customer's language), and so forth. And of course, events from email event source 202 would contain quite different fields, such as FromAddress, ToAddress (which could be a list of multiple addresses), CCAddress (again, which could be a list of multiple addresses), SubjectLine, EmailContent, and so forth. As mentioned above, an important role of event collectors 210 is to take a variety of events, each comprising its own internal structure, and to transform them into a series of events presented to complex event processing layer 220 in a consistent format. For example, the following table describes one set of mappings from various event types to a standard event type which can be used, in an embodiment of the invention, as input to complex event processing layer 220:

TABLE 1
Example of Standard Event Mapping.

| Standard Event Fields | | | |
|---|---|---|---|
| (output from event | | | |
| collectors 210) | CTI Event Fields | Email Event Fields | CRM Event Fields |
| EventTime | EventTime | EventTime | EventTime |
| EventType | EventType | EventType | EventType |
| EventID | EventID | EventID | EventID |
| EventSubject | AgentID | ToAddress (of agent) | EmployeeID (of agent) |
| EventObject | CustomerID (derived | CustomerID (derived | CustomerID (derived |
| | from OtherExtension | from FromAddress) | from CRM data directly) |
| | or ANI) | | |
| InteractionID | CallID | EmailID or ThreadID | CaseID |
| EventLocation | ACDSite | AgentLocation | CRMSite (or maybe |
| | | | not relevant, since |
| | | | CRM data may not |
| | | | be site-specific) |
| Additional Event | Skill, Queue, Site, | Skill, EmailQueue, | Skill, ProductID, |
| Attributes as appropriate, | Priority, IVRDigits | AgentGroup, Priority, | Quantity, OfferMade, |
| in form “FieldName::FieldValue” | | AutoReplySent | SaleMade |

The key point of Table 1 is that all events, from any source, can be mapped into one or more standard event protocols such as that shown in column 1, eliminating any need for complex event processing layer 220 to have detailed a priori information pertaining to specific event types it expects to receive (if more than one event protocols are used, various ways familiar to one having ordinary skill the art may be used to distinguish which protocol is being used for any given event, including adding a EventProtocol field or parsing an incoming event to see which protocol pattern matches the fields present, and then using that protocol). Rather, complex event processing layer 220 is adapted to receive events of a given basic structure from any number of event collectors 210, which themselves have the role of translating events from various event sources 200 into one or more standard protocols and submitting them to complex event processing layer 220.

According to a preferred embodiment of the invention, each event processor 211 . . . 215 may be configured for its particular event source 201 . . . 205 by means of a (usually distributed) configuration interface 250, which may be a single server, a group of clustered servers, or a distributed group of servers with one or more proxy servers serving to balance load and ensure continuous availability of a configuration subsystem. In some embodiments, configuration interface 250 maintains its own separate configuration database, whereas in other embodiments configuration data is stored in a conventional database management system used by a plurality of client applications. In yet other embodiments, configuration data may be stored in random access memory of one or more servers 250 providing configuration information, or even in flat files distributed or replicated among a plurality of configuration servers 250. Configuration interface 250 interacts with event collectors 210 to provide and update configuration data specifying, for example, details about event mapping (that is, details on how to perform mappings like those illustrated in Table 1 above), connection details to enable them to connect to their respective event sources 200 (such connection details will often comprise a host name or machine address of a machine on which an event source 200 is operating, and a port number where an event source 200 is waiting for new connections). Configuration information can be added, deleted, or changed via configuration interface 251, which is, in a preferred embodiment, implemented as a browser-based web application (it should be understood, nevertheless, that many implementation approaches for configuration interface 251 are known in the art, any of which may be used according to the invention). As each connection from a client to configuration interface 250 is bidirectional, it is possible for configuration data to be updated automatically via a notification from a configuration client such as an event collector 210. For example, an event collector 210 could notify distributed configuration interface 250 when a port number, IP address, or host machine name of one or more of its event collectors 200 has changed (for example, if two or more event sources 200 operate in a high-availability arrangement, and one of them fails, it is normal for clients to switch automatically to another member of the high availability group, and it would be necessary to inform distributed configuration interface 250 so that any subsequent connections to that event source 200 will be directed to the proper location). In a preferred embodiment, distributed configuration interface 250 also provides each event collector 210 with instructions for connecting to one or more complex event processors 221, 222, as complex event processors 221, 222 do not normally establish connections to event collectors 210 themselves. This approach is preferred (although other approaches are possible according to the invention, such as having a complex event processing layer 220 initiate connection to each event source) for at least two reasons. First, in a preferred embodiment, event collectors 210 operate within a plurality of enterprises' information technology infrastructure and networks, where they can be close to their respective event sources 200 (another benefit of this approach is that sensitive information does not need to leave the enterprise, since it can be stripped out or masked by event collectors 210 before being transmitted to complex event processing layer 220). Second, operating complex event processing layer 220 as a cloud-based service that is available to receive transformed events from any number of event collectors 210, some of which may only operate intermittently, and some of which may be mobile, allows systems according to the invention to be very flexible. A preferred paradigm is that many event collectors 210, each of which is configured on installation to connect to distributed configuration layer 250, are capable of operating in a wide variety of operating environments, physical locations, and according to a wide variety of operational patterns, and each need only have network access to be able to connect to a stationary, scalable complex event processing layer 220 in the cloud (although of course complex event processing layer is not required to be “in the cloud”, according to the invention; cloud-based operation of complex event processing layer 220 is merely a preferred embodiment). In some cases, event collectors will connect only intermittently to complex event processing layer 220, uploading event data in batches rather than continuously; this could be required, for instance, where event collectors 210 have only intermittent network access.

Complex event processing layer 220 is typically, although not necessarily, a distributed layer, with a plurality of complex event processors 221, 222. In some embodiments of the invention, a single complex event processor 221 provides services to all event collectors 210, and in other embodiments various forms of clustering, load balancing, or high availability arrangements, many of which are known in the art, may be used to provide a distributed complex event processing layer 220 that appears to its clients as a single logical machine. In the embodiment illustrated in FIG. 2, complex event processing layer 220 comprises two complex event processors 221 and 222, each of which receives events from its own designated event collectors 210. According to the embodiment, each event collector 210 may send events, in a designated common protocol, to either one or both complex event processors 220 (in other embodiments, where there are potentially many complex event processors 220, each event collector 210 is configured to send events, in a common protocol, to a plurality of complex event processors 220). In some embodiments, it is desirable for an event collector 210 to send events to only one complex event processor 220, for example when complex event processors 220 are distributed geographically to ensure that one complex event processor 220 is located reasonably close to each event collector 210. In other embodiments, it may be important to ensure that a single complex event processor 221 receives events from a particular event collector 213 even though the same event collector 213 is sending events to a second (or perhaps even a third or more) complex event processor 222. Besides the apparent robustness of such an approach (a failure of either complex event processor 221, 222 will still allow events from event collector 213 to be processed by the other complex event processor 221, 222), it may also be desirable for reasons of event processing logic to pursue such a duplicative event handling approach. In some cases, processing at one or more complex event processors 221, 222 may rely on relationships between events, and it may be necessary to ensure that events from event collector 213 are available in complex event processor 221 to be processed according to their relation to events emanating from event collectors 211 and 212; at the same time, it may be necessary for complex event processor 222 to process events from event collector 213 according to their relationship to events received from event collectors 214 and 215. In some embodiments, events or data from intermediate stages of processing may be passed directly from one complex event processor 221 to another 222 (event passing may of course proceed in the opposite direction according to the invention).

According to a preferred embodiment of the invention, output from one or more complex event processors 220 is passed to a scalable storage layer 230. In some embodiments, data layer 230 is comprised using a data management system such as Hadoop or BigTable, and in some embodiments data layer 230 uses clustering (for instance, as provided by open source software packages such as Cassandra) to further enhance fault tolerance and scalability of data layer 230. As with other components of a preferred embodiment, data layer 230 is implemented and managed in accordance with configuration information maintained in and provided by distributed configuration layer 250. Details about what data is stored in data layer 230 is provided later, in conjunction with descriptions of the operation of complex event processors 220. It should be noted though, that according to the invention any data management technology suitable for use in a highly distributed architecture may be used, and accordingly the invention should not be considered limited to any particular data storage technology or paradigm.

According to a preferred embodiment of the invention, several data manipulation applications may reside “above” data layer 230 as shown in FIG. 2. This representation is illustrative only, and not literal, and it will be recognized to one having ordinary skill in the art of large-scale data systems that there are any number of well-known architectural approaches that could be used (or a mix of which could be used) to arrange various data processing applications and data layer 230 relative to one another. Exemplary data processing applications or services include, but are not limited to, a business intelligence server 240, a machine learning module 241, a simulation engine 242, and an optimization server 243. Each of these may, according to a preferred embodiment, receive configuration information from distributed configuration layer 250, although they may also be configured separately. Each of them uses data from data layer 230 and typically sends results back to data layer 230 for storage and possibly for further processing using other data processing applications or another instance of the same data processing application. Details of what data processing is performed by each of the four data processing applications in FIG. 2 is provided below.

One main purpose of systems according to the invention is to enable staff managing complex customer care processes to readily view analytical data pertaining to those processes, to interact with analytical data, and to conduct ad hoc analyses as desired to assist in optimally managing complex customer care processes. Generally such human interactions is carried out using one or more user interfaces 260, which could be browser-based web applications, dedicated desktop computer applications, mobile computing device applications, or even voice-activated mobile telephony applications. It will be appreciated by one having ordinary skill in the art of user interface design that, for any given specific set of interactions that must be enabled between one or more humans and one or more data processing applications (and of course the data they process), there will be a multitude of workable user interface 260 technologies that are well-known in the art and available for use; any of these may be used according to the invention without departing from its scope.

### DESCRIPTION OF EXEMPLARY EMBODIMENTS

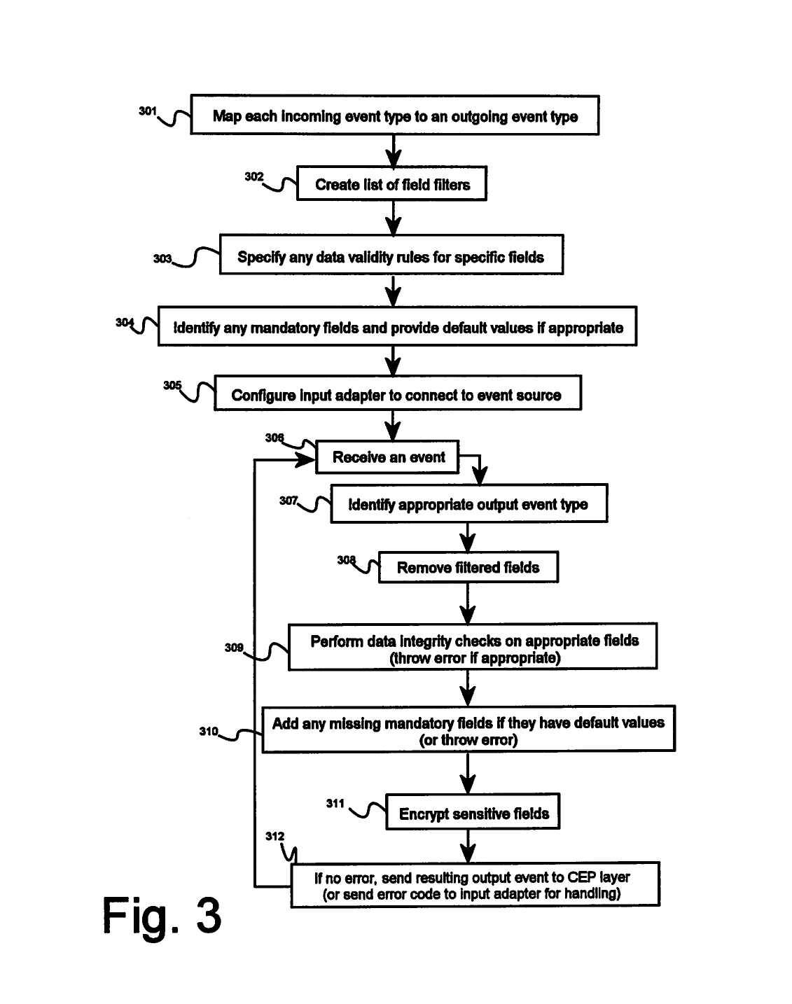

FIG. 3 is a process flow diagram of a process for event collection according to an embodiment of the invention. In a first step, generally conducted before beginning event capture operations (although it can be revisited to update mappings even after event capture operations have begun), each incoming event type is mapped to an outgoing event type in step 301. Generally this mapping is carried out using configuration interface 251, although it can also be done in other ways, for instance by building configuration files (usually but not necessarily in extensible markup language, or XML) that are read on startup of an event collector 210. For each event type expected to be received from any event sources 200 that feed events to the event collector 210 being configured, a first consideration is whether to pass the event “up the chain” (i.e., to deliver the event, suitably modified, from event source 200 to complex event processing layer 220); in some cases, certain received event types (that is, events received from an event source 200 corresponding to a particular type) will be filtered out at this step and simply ignored. For received event types that are to ignored, either a flag is set specifying this fact, or a null value is placed in configuration data for the output event type (which effectively means that the incoming event type will be ignored). For received event types that are not to be ignored, an output event type is specified. In step 302, a list of field filters is created. Field filters are used to identify fields, in incoming events of a particular type, that are to screened or ignored (that is, that will not have a corresponding output event field). Again, either a flag can be used to designate fields to be ignored for a given event type, or such fields can be given a null output field value. Then, in step 303, data validity rules for certain fields are specified. Data validation is a well-established practice in the art of computer programming, and can be performed in many ways known in the art. For example, a rule might be established that states that “extension number of a phone call must be between 1000 and 5000”, based on configuration of a site's ACD 115, or a rule might state that a field named “Skill” must contain either NULL as a value or a value that is contained in a specific set of possible values (this is an example of a data validation rule that prevents inadvertent misspelling of a field such as “Skill”, which misspelling could have the effect of adversely affecting statistical calculations made using the affected data). In a similar vein, it is often important to specify that certain data fields are mandatory. Accordingly, in step 304 mandatory fields may optionally be designated and default values can be supplied for those fields (but need not be). A default value is one which, when no value is passed in with an event, is inserted in order to ensure that the mandatory field has a sensible value. In some cases, no default value is provided, in which case any incoming event that lacks the mandatory field would cause an error to be thrown.

In step 305, an input adapter is configured to enable it to connect to an appropriate event source 200. An input adapter is a software module within an event collector 210 that, on startup of the event collector 210, establishes a connection to the applicable event source 200. Typically configuring an input adapter requires specifying a machine name or network address of the machine on which the applicable event source 200 resides, and usually also a port number specifying the port number on that machine where event source 200 maintains an open port that accepts new connections. In some cases, other data, including but not limited to application name of the connecting client (in this case, the name of the event collector 210 being configured), an application password, possibly a role designator that specifies what role(s) the connecting application (that is, the event collector 210 being configured) will carry out with respect to the event source 200, and so forth. It will be recognized by one having ordinary skill in the art of interprocess communication that there are essentially unlimited permutations of configuration data elements that may be required to enable event collectors 210 to connect to various event sources 200.

Once steps 301 through 305 have been completed, event collector 210 is ready to connect to one or more event sources 200. In some cases, steps 301 through 305 may be repeated periodically, or when certain triggers or conditions are met, in order to refresh the various event mapping, field filtering, data validation, and mandatory field rules for a given event collector/event source combination (for example, if event source 200 is upgraded to a newer version with an additional set of possible events it could generate).

When event collector 210 is configured and connected to one or more event sources 200, a series of steps are carried out in a loop that continues indefinitely, until either event collector 210 or event source 200 shuts down or some other signal is provided to cause event collection to cease. The first of these repeating steps is typically step 306, in which event collector 210 receives an event from an event source 200. Once an event is received, in step 307 an appropriate output event type (if any) is determined. Output events are those sent “upstream” from event collector 210 to complex event processing layer 220. Not all events received by event collector 210 will have corresponding output event types; in effect event collector 210 acts as a first filtering layer, filtering out unwanted, unnecessary, or redundant events received from event sources 200. Similarly, not all output event types correspond to a particular single input event type (that is, input from event sources 200); in some cases, a plurality of events of different types may be associated with a single output event type. This would be appropriate, for example, if event sources 200 were of different types, for example CTI servers and email servers, and thus would have quite different event sets. In such cases it will still usually be the case that certain CTI events correspond to an initiation of a new communications session (or call), and certain different email-related events would serve the same purpose of signaling the initiation of a new email interaction. It would be natural, in this case, to associate both types of events (CTI and email interaction initiation events) with a more abstract session initiation output event type (generally while retaining certain attributes or data elements that are distinctive to the different event sources 200). Furthermore, in some situations it may be desirable to associate a single incoming event with more than one output event type in step 307; in general event-based models can be arbitrarily complex, in keeping with their purpose as a means of modeling real-world processes, which often are themselves quite complex.

Following determination of an appropriate output event type or types, in step 308 any data fields in an incoming event for which filtering rules have been established will be filtered out. This is often necessary because raw events coming from event sources 200 will often comprise one or more sensitive data elements such as a consumer's name or account number. Then, in step 309, data integrity checks may be performed on one or more appropriate data fields within a received event. Data integrity checking is well understood in the various arts associated with computer science, and can take many forms. When a data integrity constraint is found to be violated in a received event, an error may be thrown, and any constraint-violating data may also be filtered or replaced with a default value. Furthermore, in some cases it will be desirable, according to various embodiments of the invention, to identify one or more mandatory data elements, either for a specific event type or for a set of specific event types (including possibly all events). For example, a field named EventTime might commonly be configured as a mandatory event; in cases where an incoming event specified no such data element, one would be created in step 310, and typically populated with a system time or another appropriate default value. In general, when a data element is specified to be mandatory for one or more event types, it is desirable to specify a default value, or a default means for assigning a value (such as using system time to populate a missing EventTime field, as just described), although this is not necessary according to the invention. In cases where a mandatory field is not present in a received event and no default value is specified, and no means for assigning a value is provided, then normally a data element will be created (since it is a mandatory data element) and given a null value. Next, in step 311, any data elements that need to be retained but are nonetheless sensitive may be encrypted before sending up to complex event processing layer 220. For example, it is commonly necessary, in customer contact center operations, to be able to determine whether and when any given consumer has contacted the center previously. If all consumer-identifying information was eliminated in filtering step 308, then there would be no way to make this determination. However, if at least one consumer-identifying data element is retained and encrypted in step 311, it will generally be possible for users of data stored in a cloud-based analytical system according to the invention to make such a determination without having to store consumer-identifying information “in the cloud”. While there are many ways known in the art, and readily available to one having ordinary skill in the art, of encrypting a data element, any of which may be used according to the invention, in a preferred embodiment event collectors 210 perform encryption using an encryption key known to an owner of data, but not known to an operator of a cloud-based analytical system according to the invention. In this way, sensitive data is encrypted and thus not subject to theft in the cloud, but it will still be possible to determine that a particular consumer interacted with a contact center more than once (because an identifying data element, such as an account number or a home telephone number, will yield the same indecipherable encrypted string each time it is encrypted, and thus the fact that “this data appeared in this field before” is known, but not “this data corresponds to Joseph Smith of Danbury, Conn.”). Finally, if no error has occurred in the series of steps carried out on receipt of an event from an event source 200, a corresponding output event, with all appropriate data elements present (possibly but not necessarily including encrypted elements) is sent to complex event processing layer 220.

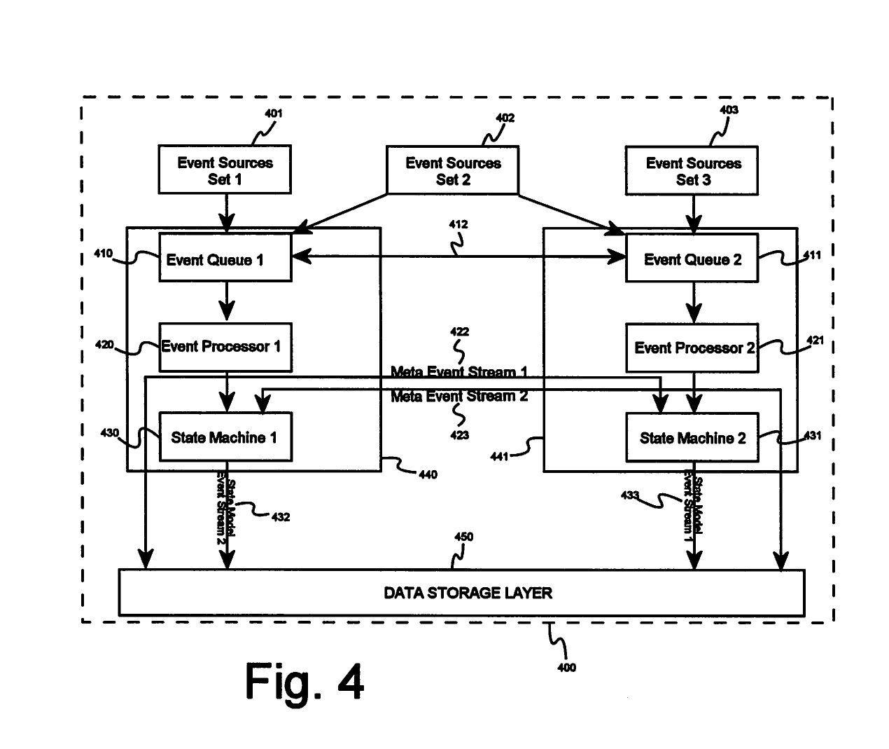

FIG. 4 is a block diagram illustrating a complex event processing layer 400, according to an embodiment of the invention. Using systems and techniques described above, event sources 401-403 (taken for purposes of discussing FIG. 4 as including both event sources 200 and event collectors 210, operating as integrated units from the perspective of complex event processing layer 220) deliver streams of events to complex event processor 440 or complex event processor 441. In general, event sources 401-403 are collocated with the systems from which their events emanate; that is, for example, event sources set 401 might be deployed at contact center 100, event sources set 402 might be deployed at call center 101, and event sources set 403 might be deployed in a third location handling only a specific kind of interaction that generates events (for instance, a short messaging system (SMS) service in a telecommunications network). However, it should be appreciated by one having ordinary skill in the art that event sources 401-403 could be deployed anywhere that is accessible via one or more data networks to one or more complex event processing systems 440, 441. As shown in FIG. 4 for illustrative (but not limiting) purposes, event sources set 1 401 sends events only to complex event processor 440, event sources set 3 403 sends its events only to complex event processor 441, and event sources set 2 402 sends at least some of its events to each of complex event processor 440 and complex event processor 441. While such an arrangement with respect to event sources set 2 402 might commonly be carried out to provide redundant complex event processors to handle a given stream of events (in which case generally all events emanating from event sources set 2 402 would be provided to each of complex event processor 440 and complex event processor 441), it is also possible that only some subset of an event stream emanating from event sources set 2 402 is sent to complex processor 440 and some other subset to complex event processor 441, for reasons other than redundancy. For example, complex event processor 440 might have a need to monitor groups of possibly-related events, some of which arrive from event sources set 1 401 and some from event sources set 2 402, while complex event processor 441 might similarly need to monitor groups of possibly-related events arriving from event sources sets 2 and 3 402, 403.

Within each complex event processor 440, 441, events are received into an event queue 410, 411. In some embodiments, either to augment or to substitute for event distributions from one or more event sources 401-403 into complex event processors 440, 441, events are replicated 412 between event queues via one or more data networks. Event processors 420, 421 receive events as they are dequeued form event queues 410, 411 and process them as described below, generating one or more metaevents as output. Metaevents are delivered from event processors 420, 421 as metaevent streams 422, 423 to state machines 430, 431 and optionally to data storage layer 450 (this is done whenever it is desirable, as it often will be, to store metaevents directly and persistently to allow their later retrieval by analysts or analytical applications. Additionally, in some embodiments it is desirable for metaevent streams to be replicated across two or more state machines 430, 431 from one or more event processors 420, 421 in order that each state machine 430, 431 will in principle be able to maintain its internal state model using complete sets of metaevents. In other embodiments, some or all metaevents will be sent only to one or more specific state machines 430, 431, but not to every state machine 430, 431, for example when some state machines are explicitly configured to model only specific types of interactions or processes. State machines 430, 431 receive metaevents from metaevent streams 422, 423 and use them to update internal state models. As will be described in detail below, in some cases state changes caused within one or more state machines 430, 431 by an incoming metaevent may require generation of a state model event; for example, if a metaevent corresponding to a contact center agent's receiving an email is placed on a metaevent stream 422 and received by a state machine 430, it may be that the arrival of the email places the particular agent in a state where she cannot receive any other interactions or work tasks, whereas in other situations the same metaevent might not trigger such a condition (as for example when an agent can handle up to some specific quantity of emails, and the agent has not yet received that quantity). In the first case, a signal is needed to indicate that the agent cannot receive any more interactions, while in the second case no such signal is required. This is an example of a situation where a metaevent arriving from a metaevent stream 422, 423 into a state machine 430, 431 will only sometimes require generation of a specific signal, and the requirement will depend on an internal state model maintained by one or more state machines 430, 431. Because of this conditional event-firing (that is, signal-sending) outcome stemming from a single metaevent, it is usually necessary to provide for generation of state machine events by state machines 430, 431; such state machine events are placed in a state machine event stream 432, 433, from where they are distributed to data storage layer 450.

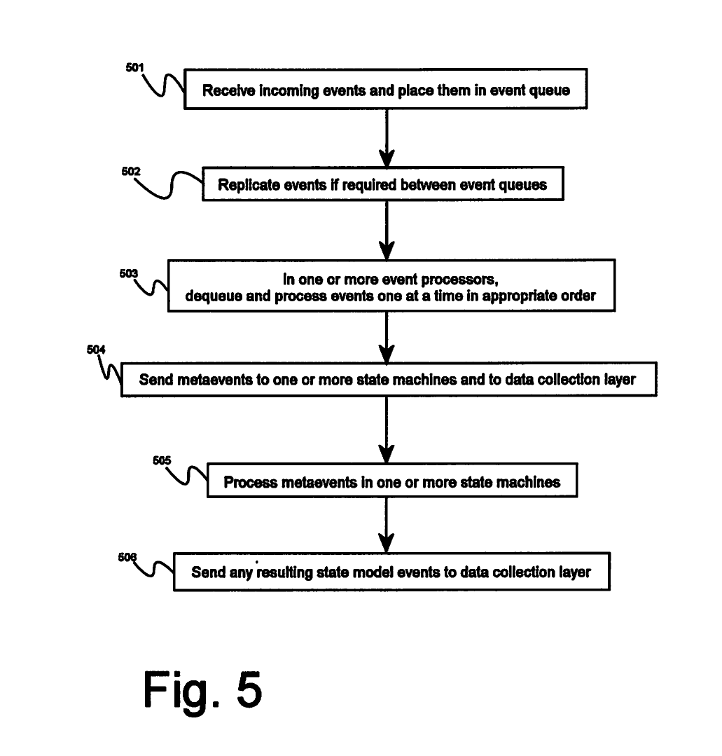

FIG. 5 is a process flow diagram illustrating a process for complex event processing, according to an embodiment of the invention. The process is generally carried out using a system such as that shown in and described with reference to FIG. 4. In a first step 501, incoming events are received from one or more event source sets 401-403 into an event queue 410, 411. In step 502, some events may be replicated between two or more event queues 410, 411. In step 503, events are dequeued to one or more event processors 420, 421. Event processors 420, 421 generally process events in the order they were dequeued from event queues 410, 411, although this is not required according to the invention and other event-ordering systems can be used. Processing of events is carried out according to preconfigured complex event processing rules. It should be apparent to one having ordinary skill in the art of complex event processing systems that there are many kinds of rules useful for making sense of complex event streams, any combinations of which may be used according to the invention. For example, in some cases simple aggregation rules intended to “collect” related events that arrive simultaneously or nearly so in event queues 410, 411. This kind of rule is useful when several lower-level events are fired as a result of some underlying metaevent that correspond to what would more naturally be considered to be the “real event”. To make this clear, consider a situation when an incoming phone call is delivered from a queue in ACD 115 to an agent 130. It is common for several “raw” events to be fired by CTI server 120 in this situation:
EventDiverted to indicate the call was diverted from a queue in which it had been placed;
EventRouteUsed to indicate that a routing strategy used by a routing engine controlling the queue in ACD 115 had completed and made a target selection;
EventRinging to indicate that a phone associated with agent 130 rang; and
EventEstablished to indicate that a connection had been established between agent 130 and a consumer using (for example) phone 160.

While these four events each refer to separate lower-level events, in this case describing activities at a queue, a route point, and an agent phone, and while each might contain one or more data elements not contained in the others, from a business process perspective they can better be understood (and analyzed and reported on) as a single metaevent, for instance called MetaEventCallDelivered. A metaevent will typically contain a superset of data elements contained in a set of lower-level or raw events that generated the metaevent, although this will not always be true. In some cases, one or more incoming events might operate to trigger a complex event processing rule that requires generation of a particular metaevent, but might not actually contribute any data to the resulting metaevent.

Accordingly, according to the embodiment, in step 504 one or more metaevents that result from processing carried out in step 503 are passed to one or more state machines 430, 431 (and optionally to data collection layer 450 for persistent storage). Then, in step 505, the one or more receiving state machines 430, 431 process the one or more metaevents resulting from step 503. Finally, any state model events resulting from the processing of step 505 are sent, in step 506, to data collection layer 230 for storage and subsequent retrieval by high-level applications.

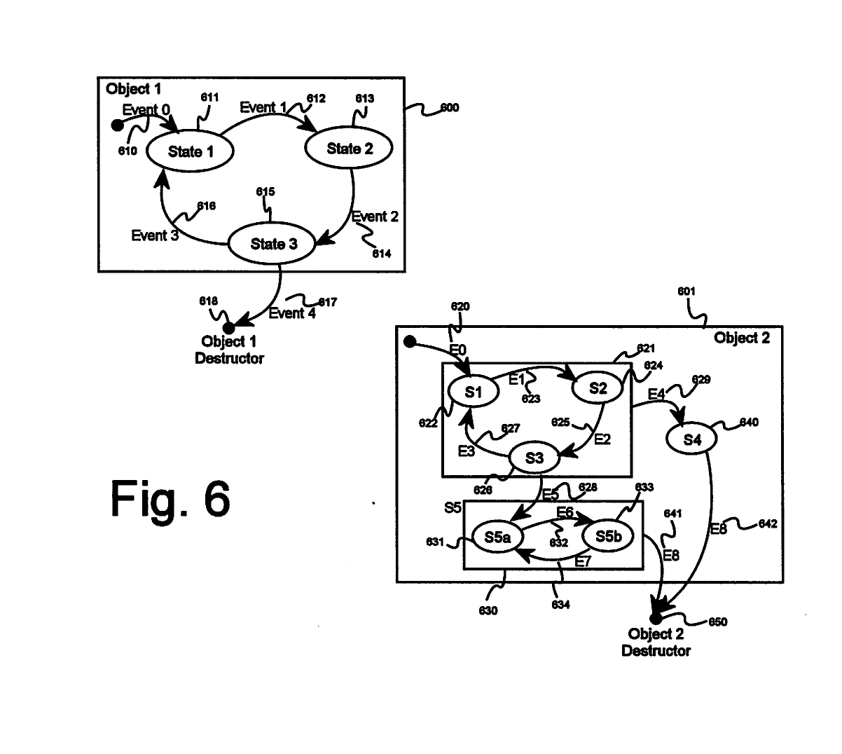

Processing carried out in step 505 is carried out, as mentioned, in one or more state machines 430, 431. FIG. 6 discloses an illustrative pair of state charts 600, 601, each an illustration of an embodiment of a state machine 430, 431 according to the invention, and illustrates relationships between states, objects, and events, according to an embodiment of the invention. State machines can also be referred to as state models; the first usage highlights the fact that state machines act on incoming events and may fire outgoing events or take other actions in response to state changes, whereas the second usage highlights the fact that state models achieve much of their value or utility from the fact that they are very helpful tools for modeling real world objects or processes as their internal states change in response to external stimuli (and as they in turn act on their environment).

State model 600 represents a fairly simple model of an object type with only three states: state 1 611, state 2 613, and state 3 615. A solid dot at the base of an arrow, such as at the base of transition 610, represents an initial state of the state model. When state model 600 is started, it always does so in state 1 611. In some cases an initial event 0 610 is included, although in some cases “startup” in effect acts as an event, and the “transition” to state 1 611 from “model not in any state” merely represents what “happens” when the object represented by state model 600 is instantiated. On instantiation, an object represented by state model 600 undergoes any startup processing (which would typically be implemented as an event handler script for event 601), and at the conclusion of any such startup processing is considered to be in state 1 611. According to state model 600, if an object represented by the state model is in state 1 611 and an event of type event 1 612 occurs (with the object being modeled as the subject, or actor, of the event; not all events of type event 1 612 trigger changes in state model 600, but only those events of that type that are linked to the object modeled by state model 600), then the object modeled by state model 600 transitions to state 2 613; again, there may be code or scripting that is executed upon a beginning, during, or on conclusion of such a transition. Similarly, if an event 2 614 occurs that pertains to the object modeled by state model 600, the object's state transitions to state 3 615 and any event-handling or transition-fired scripting or code is executed. And again, if an event 3 616 occurs for the relevant object, the object's state transitions back to state 1 611 with any appropriate actions being executed. If, on the other hand, while an object represented by state model 600 is the subject of an event 4 617, then the object is destroyed typically by object 1 destructor 618, a module responsible for cleanup and exit code for the object. With this simple model in mind, and before going on to the more complex model represented by state machine or state model 601, several useful terms can be defined. A “state machine” is an executable software module that is adapted to receive events and to take actions in response to those events, and to maintain an internally consistent representation of the (sometimes complex) state of an “object” that is an instance of the “object type” represented by the state machine, which therefore is also effectively a “state model” of the object type in question. Event 0 610 acts as what is known in the art of object-oriented programming as a “constructor”, which is a set of code or computer-operable instructions that are to be carried out immediately upon creation or instantiation of an object of the type modeled. State 1 611 is therefore known as an “initial state” (there can be more than one, where a state model allows parallel states, as for example when a person is simultaneously in the states of “alive”, “awake”, and “at work”. In state model 600, only one state (state 3 615) acts as an “exit state”, because in only one case, which starts in state 3 615, is an event modeled that leads to a destructor. It should also be noted that state model 600 does not allow all possible event/state combinations; if event 4 617 was fired while object 600 was in state 1 611, then in most implementations an error would be thrown and object 600 would remain in state 1 611 (although it is possible to implement a state model so that such an event would fire a pair of “implicit events” to take object through state 2 613 to state 3 615, to allow the event 4 617 to be meaningful; such a use of implicit events is often desirable when it is difficult or impossible to observe internal events of an object).

State model 601 model an object 2 of a different, more complex, object type. As before, an initial event E0 620 places state machine 601 in its initial state S1 622. State S1 622 is one of three internal states of a larger state S0 621, so that object 2 601, on instantiation, is placed both in state S1 622 and in state S0 621. While in state S0 621, events E1 623, E2 625, and E3 627 can cause the internal states of S0 621 to change (from S1 622 to S2 624, to S3 626, and back to S1 622), while object 2 601 remains in state S0 621. Similarly, if object 2 601 is acted on by event E5 628 while in state S0 621 (regardless of which of its internal states), in transitions to state S5 630, which contains internal states S5a 631 and S5b 633. State S5 630 has an initial state of S5a 631 (indicated by the fact that E5 628 terminates at S5a 631), and can transition between internal states with events E6 632 and E7 634. State S4 640, on the other hand, has no internal states; it can be reached by the occurrence of event E4 629 while object 2 601 is in state S0 621, regardless of which os S0's internal states is currently “active”. Finally, object 2 601 has two possible exit states, S5 630 and S4 640, from either of which it may reach its destructor 650 through firing of event E8 641, 642.

The two illustrations of FIG. 6 are by no means exclusive. It will be understood by those having ordinary skill in the art of state modeling that essentially any real world, abstract, or virtual system or object can be represented by a suitably complete state model such as those shown in FIG. 6. Many more details of state modeling are known in the art, including for instance the use of parallel states as described above, and state modeling can be implemented in any of a number of technologies well-known in the art, including Harel state charts (of which state models 600 and 601 are examples) and markup languages such as state chart extensible markup language (SCXML). FIG. 6 illustrates, though, an abstract view of what is accomplished by state machines 430, 431 as they receive a stream of metaevents from complex event processors 420, 421. State machines 430, 431 maintain internal state models such as those illustrated in FIG. 6 for each object with respect to which any events are collected by event source sets 401-403. According to a preferred embodiment of the invention, state machines 430, 431 do not necessarily have to use rigid state models such as state models for objects 1 600 and 2 601. When a state model for an object type changes, each currently monitored instance of the object type is considered in turn by state machines 430, 431; if all current states of an object also exist in the new state model, then nothing changes (since the object remains in the same states). But if the current states are inconsistent with the new state model (either because they aren't present, or because the object type is not allowed to be in the current combination of states), then either an error is thrown to be handled by an error handling module, or a set of implicit events is thrown to move the object instance to an allowable state according to the new state model. Thus it is an important object of the invention that state models are flexible, easily-modified or indeed added to (for example, to add a new object type to be monitored by a system operating in accordance with a preferred embodiment of the invention, all that is needed is to use distributed configuration subsystem 250 to notify event collection layer 210 that there are new event sources 200 to monitor, to add or modify complex event processing rules carried out in complex event processing layer 220 that there are new event types to handle, and to add or modify suitable event models to state machines 430, 431 in order to allow them to make sense of metaevents arriving as a result of events generated by or because of the new objects.

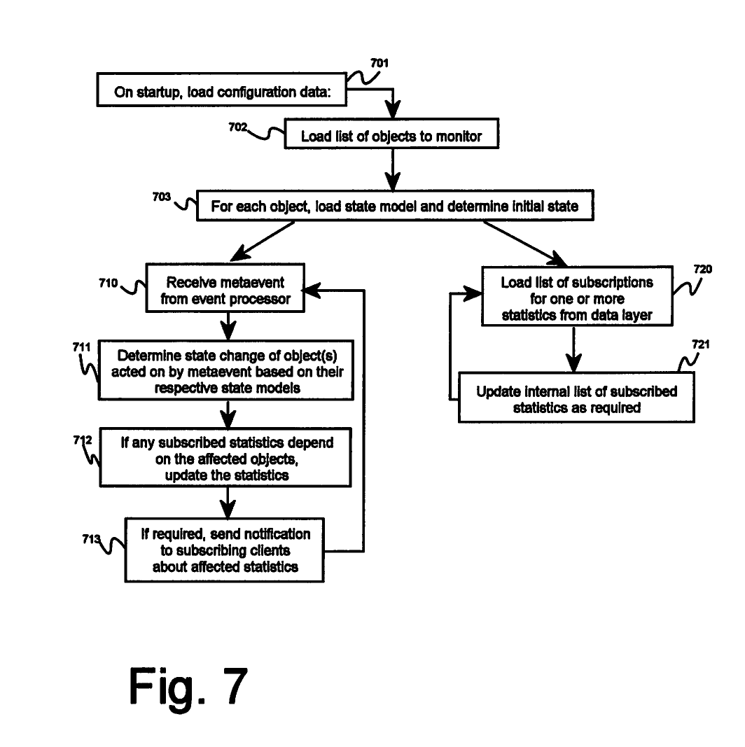

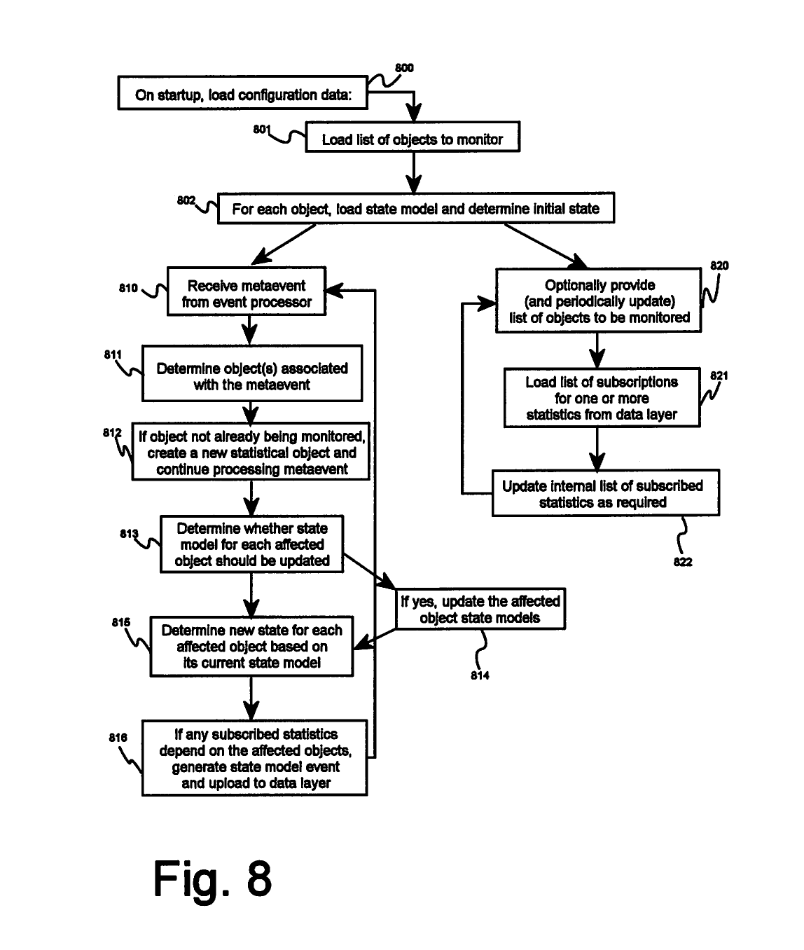

State machines 430, 431 not only maintain an up-to-date realization of the state of a plurality of objects based on metaevents received from complex event processors 420, 421, but they also act as statistics servers to client applications, providing a wide range of easily configurable statistical data pertaining to individual objects and collections of objects. Considering FIG. 7, which is a process flow diagram illustrating a process for managing flexible state machines 430, 431 according to an embodiment of the invention, this capability will be made clear. On startup of state machine 430 (all discussion with respect to FIGS. 7 and 8 apply equally to any state model or state machine, and state machine 430 is singled out solely for illustrative purposes), in step 701, state machine 430 loads configuration data from configuration subsystem 250. Configuration data will be extensive, including identities and connection data for each complex event processor 420, 421 to which state machine 430 may connect, as well as data pertaining to data storage subsystems 450. But in particular, in step 702, state machine 430 obtains a list of objects to monitor (“monitoring an object” means to receive a stream of metaevents or events pertaining to the object, from either or both of complex event processors 420, 421 or directly from event collectors 210). Configuration data for each object to be monitored will generally include information about what event collector 210 (or indeed what plurality of events sources 210, since more than one event source 210 may emit events pertaining to any particular object that is to be monitored) will be a source for events pertaining to this object, as well as information such as an identity of a specific state model to apply when interpreting events pertaining to the object. Alternatively, an object type for each object to be monitored may be provided in step 702, in which case an association (typically stored in configuration subsystem 250) between an object type and a state model is stored. In step 703, for each object to be monitored, an appropriate state model is loaded into state machine 430, 431; a particular state model is determined either because it was explicitly identified in step 702 or because it is associated in configuration subsystem 250 with an object type to which the object to be monitored belongs. Following step 703, two typically independent, parallel chains of activities ensue. In step 720, a list of subscriptions for one or more statistics is received from data layer 230 or directly from one or more client applications that require statistics pertaining to one or more objects, either in real time or pertaining to a period in the past (commonly referred to in the art as historical statistical data). Subscriptions typically provide a list of objects, or a particular class of objects, or a filter operation that determines a subset of the set of all objects, for which statistics are desired by a subscribing entity. Use of a subscription model as outlined her is helpful, according to the invention, because in even a modestly sized contact center, it would not be feasible (or at least not cost-effective) for every possible statistic was calculated for every possible object; by allowing client applications to subscribe to particular statistics pertaining to particular objects or classes of objects, and then only computing statistics as required for currently subscribed statistics, state machine 430, 431 are not confronted with a massive scaling problem. In step 721, internal lists of subscriptions for statistics are updated periodically (or on demand), as required, in order to allow client applications to add and drop statistics as needed. In a preferred embodiment, statistics are required to be re-subscribed for periodically, and in some embodiments statistics are automatically unsubscribed when either the subscribing client failed to re-subscribe as required or if the subscribing client does not maintain a connection to state machine 430, 431 for some required period; enforcing such policies further mitigates scaling problems for state machines 430, 431.

In a parallel execution path that represents a primary operating mode of state machines 430, 431, in step 710 an event (or a metaevent; the two can be considered interchangeable for purposes of downstream processing) is received from an event processor 420, 421 at a state machine 430, 431. Then, in step 711, state machine 430, 431 determines whether any state changes occur in response to the received event, referring to state models 600, 601 for each object acted on or referred to by the event. For example, a telephony event signifying that a call has been established at a particular agent's workstation 130 may signify a change in state for the affected agent from “Ready” to “Not Ready” (to receive calls); this state change would be specified in a state model 600, 601 for agents (or at least for agents of the same kind as the agent who received the call). The, in step 712, state machine 430, 431 determines whether any subscribed statistics have been affected as a result of the received event and any consequent state changes of objects. Note that it will be quite common, according to the invention, for multiple statistics to change on receipt of an event at state machine 430, 431. One reason is that an object that is acted on or changed by an event may be part of a collection of objects, or of a statistical aggregate being tracked by state machine 430, 431. For example, when an agent goes into “Not Ready” state (and presumably also “On Call” and other similar related states), a statistic representing number of calls received by agents in the affected agent's group will be augmented by one based on the newly arrived call; at the same time, the complete time the agent spent in “Ready” state before receiving the call may be added to several statistics computing time-based statistics, such as “total ready time for agents in group”, “average ready time for a particular agent”, “busy factor for all Spanish-speaking agents”, and so forth. Once all affected statistics have been updated, in step 713 state machine 430, 431 may, if required, send notifications to subscribing clients concerning changes in the affected statistics. Note that steps 712 and 713 might not, in some embodiments, occur in strict sequence; in some embodiments as each statistic is updated it is immediately transmitted, if required, to subscribing clients. Also, in many embodiments not every statistical change is transmitted to every subscribing client (or even any subscribing client). For example, in some embodiments only statistics that have changed by at least a minimum threshold amount will be reported to clients; in other embodiments, certain statistics may be subscribed to for strictly periodic updates (typically every 15 minutes)—changes occurring more frequently are taken into account, but only once per period is an update notification sent to subscribing clients. Once all affected state changes and required statistics have been updated and any notifications sent to clients, execution loops back to step 710, where state machine 430, 431 waits for another event or metaevent.

An important aspect of the invention is that, unlike statistical systems known in the art, according to the invention and as illustrated with reference to FIG. 7, state machines 430, 431 are able to work with variable state models. At any time during operation modifications to state models 600, 601 can be made within configuration subsystem 250 or elsewhere (although if made elsewhere they will typically be stored in configuration subsystem 250), and the modified state models become immediately effective. In some embodiments, it may be necessary to provide mappings that specify how an object currently in a particular state derived from a current state model will migrate to a new state when its state model is changed during operation (thus in essence mapping the old state model onto the new state model, at least for purposes of managing the transition). This is important because a new state model might be loaded while an object is being monitored, and such a change might not be associated with any particular event or metaevent concerning the object. In such a case, a method is needed to map the current state of the object from its current state defined in terms of the old state model onto the new state model; the mapped-to state, which may be a complex state, would in such a case be functionally equivalent to the “old” state under the old state model, since no state-changing event had occurred. In some embodiments, one-time mapping models that map an existing state model onto a new state model may be included in a configuration of a new state model, so that state machines 430, 431 may, on loading the new state models, automatically map all existing effected object states from the old state model onto the new state model without loss of state awareness.

Another aspect of providing a rich dynamic state model capability, which is one of the objects of the invention, is illustrated in FIG. 8, which is a process flow diagram illustrating a process for managing a flexible state machine using dynamic state models, according to an embodiment of the invention. As in FIG. 7, in a first step (step 800), when a state machine 430, 431 starts up or is instantiated, configuration data is loaded, and in step 801 a list of objects to monitor is loaded. Importantly, it is not necessary, according to the embodiment, for all (or even any) of the objects that ultimately will be monitored to be loaded in step 801, because according to the embodiment objects can be added or even discovered dynamically. Also as in FIG. 7, in step 802 a state model may be (but need not be) loaded for each object to be monitored, and a determination may be made of each object's initial state based on any loaded state models. Similarly, steps 821 and 822 correspond to steps 720 and 721. But step 820 is new; it optionally provides for provision and periodic updating of a list of monitored objects that may be obtained by clients that use statistics generated by state machines 430, 431. Having an available list of objects being monitored, and optionally their types and state models as well, is important when it is possible for objects to be added or dropped at any time (as will be described shortly), and when objects' state models may be progressively discovered and thus revealed to clients progressively (also discussed shortly).

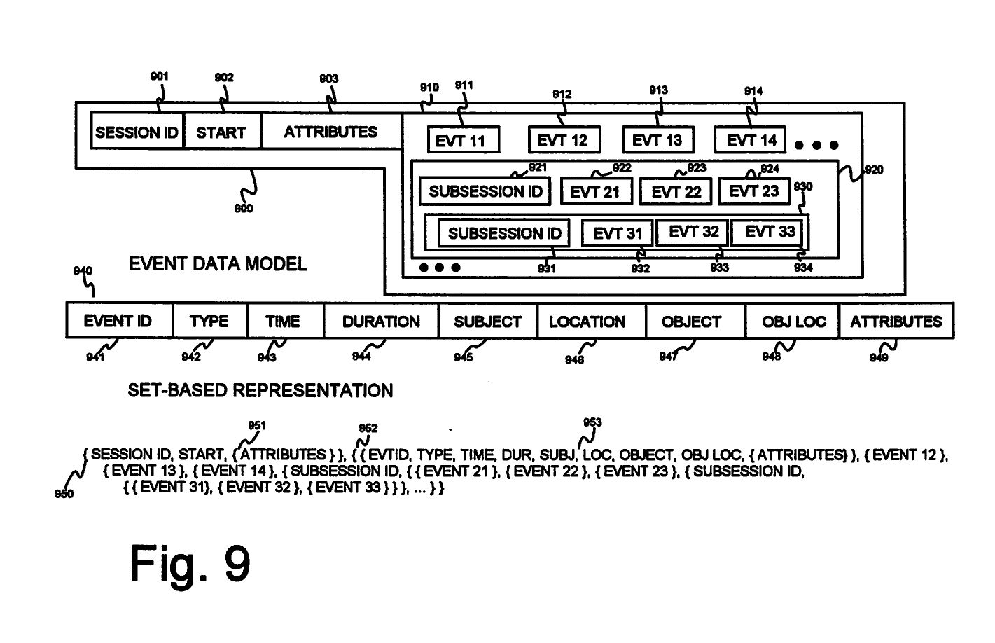

Considering the parallel sub-process starting with step 810, as before an event or metaevent is received at state machine 430, 431. In step 811, state machine 430, 431 determines what objects, if any, are associated with the event (or metaevent, although again the two are interchangeable for the purposes of FIG. 8). This step is implicitly carried out in the process outlined in FIG. 7, but is highlighted here to emphasize the possibility that objects that have never been configured or perhaps even seen before by state machines 430, 431 can in fact be present as actors or objects (things acted upon) of an event received in step 810. In general determination of objects associated with an event is carried out by examining the semantic structure of the received event. In many cases, as will be illustrated with reference to FIG. 9, one field will explicitly be labeled or configured as the “subject” of the event—an actor carrying out an action which is expressed or recorded by the event. While in general events will have only one subject, it is possible within the scope of the invention for an event to have more than one subject, and it is only necessary that some means (such as attribute labels or predefined fields or sets of fields designated to contain subject actors, or a single such field which may contain a list of actors). Similarly, some but not all events may have objects in the semantic sense—things which are acted upon by an event's action, by the event's subject (or subjects)—but events may have one or more objects that can be determined either implicitly or explicitly from the structure or content of the event. Then, in step 812, for each object identified, state machine 430, 431 determined whether the object is already being monitored or not. If an object is not being monitored when an event occurs with which it is associated, then in step 812 state machine 430, 431 creates a new statistical object (that is, a new data structure in its memory that it will use for computing and containing statistical data pertaining to the newly monitored object) corresponding to the previously unmonitored object, and it adds the object to its list of monitored objects. If the newly monitored object is part of any existing aggregate or collective object for which statistics are being tracked (for example, if the newly monitored “object” is an agent, and there are statistics being computed for “all agents”), then each of the subscribed statistics affected by the addition of the newly monitored objects is updated.

Once all objects (here used in the sense of a thing, rather than in the sense of a part of the semantic structure of an event or sentence) have been identified in step 811 and any statistical changes have been made in step 812, in step 813 state machine 430, 431 determines whether state models associated with any of the objects identified in step 811 should be updated, and if so the affected state models are updated in step 814; in either case, execution then continues with step 815. The determination of whether a state model 600, 601 for a particular object needs to be changed is made based on whether the event received is inconsistent with the existing state model. In many cases where full state models are preconfigured for specific object types, an event which occurs that is inconsistent with that state model (in that it occurs while the object is in a state for which the event is not an allowable event according to the state model) is rejected as an error. However, in many real world situations it will not always be possible to conclude that an unexpected event is an error, since objects in the real world do not always follow idealized models (or at least, not all the time). In some cases, however, it is desirable that a system according to the invention be able to operate in the absence of complete, preconfigured state models, which can occur either because an object associated with an event is of an unknown type, or because the state model of an object associated with an event has not been determined, or has not been determined completely (a complete state model is one that is internally consistent and captures all allowable states and transitions). In some embodiments, state models 600, 601 may be flagged as “complete” or “incomplete”; when incomplete, unexpected events do not generate errors but do satisfy the test of step 813; when complete, unexpected events do generate errors and do not satisfy the test of step 813. It is anticipated that, even when automated state model development occurs (via repeated use of step 814), it will often be the case that humans will review such computer-generated state models in order to make additions, correct perceived errors, and possibly to classify the state model as “complete”. In some embodiments, even complete state models will be allowed to be extensible via the use of steps 813, 814, with or without human confirmation of proposed changes.

Once new objects and state models, or changes to state models, have been detected or carried out, steps 815 and 816 proceed analogously to steps 711 through 713 in FIG. 7.

It is often the case that customer interactions take on complex forms; for example when a call arrives at a call center, it might first be queued, then delivered to an agent, who might place the call on hold in order to start a second, related, “consult call” with a colleague, and the agent might then conference in the colleague with the original customer caller, thus “bridging” the first and second calls, and then at the end the agent might transfer (using one of several possible techniques for transferring calls) the call to an interactive voice response unit for an automated customer satisfaction survey. In most ACD 115 systems' call detail reporting systems, the scenario just described would lead to two or three separately identified and reported calls. The situation is even more problematic for non-telephony interaction types, as they often will have quite complex structures that are not easily analyzed using simplified “call detail record” approaches (where data about each “call” is stored in a separate row in a database, and connections between “calls” are either missing or hard to follow). Accordingly, FIG. 9 discloses an exemplary data model suitable for path analytics, according to an embodiment of the invention. According to the embodiment, each customer interaction is treated as a hierarchical session data structure 900, with an arbitrarily large number of subsessions 920, which themselves may have subsessions, and so forth.

According to the embodiment, session 900 comprises a root node that contains data pertaining to the overall session. Typical elements of a session root node include, but are not limited to, a session ID 901 (which would typically, but not necessarily, be a global unique identifier or GUID), a start time 902 which corresponds to the time at which an earliest event associated with session 900 occurred (usually provided in a standard form such as universal computer time), and a plurality of attributes 903 which are in effect global session attributes. Common global attributes 903 might be customer satisfaction score (if available), media type (if one type is used for all subsessions), primary skill, call/session type (sales, service, collections, etc.), and the like. Following the root node, session 900 comprises an overall session path object 910, which contains a sequential record, for the root session and each subsession 920, of all events that together made up the session (and subsessions 920). For example, in FIG. 9 session 900 has path data 910 that includes, for the root session: event 11 911, event 12 912, event 13 913, and event 14 914. Subsession 920 comprises subsession ID 921 event 21 922, event 22 923, event 23 924, and subsession 930. Subsession 930 in turn comprises subsession ID 931, event 31 932, event 32 933, and event 33 934. The ellipsis below subsession 920 indicates there may be one or more additional subsessions within session 900. The events shown in session 900 and its subsessions are comprised, in an exemplary embodiment, of an event data structure or event data object 940 comprising an event ID 941, an event type 942, an event time 943, an event duration 944 (not all events have duration, however; for example, an event called “call abandoned” has no duration—it records an instantaneous occurrence), an event subject 945 (this is a subject in the semantic sense, as discussed above with reference to FIG. 8), an event location 946, one or more event objects 947 (again, in the semantic sense of something that is acted on, through the event, by the event subject), each with its own object location 948, and one or more event attributes 949. Note that while one or more event objects 947 may be provided for in separate data elements, in some embodiments a list of event objects 947 is provided as a single data element within event data structure 940.

In some embodiments, session data is stored in a set-based data structure 950, which is quite amenable to rapid analysis using set theoretic algorithms. Note that set-based representation 950 stores equivalent or identical information as session data structure 900, the differences being not only between two logically equivalent representations, but also between two logically equivalent methods of digitally representing and storing information pertaining to a session. Set-based session representation 900 comprises, like session data structure 900, a session ID and a start time; analogous to attributes 903 is a list 951 of attributes. Representation 900 further comprises a list 952 made up of a plurality events 953 (which are also lists of data elements, each list typically comprising an event id, an event type, an event time, an event duration, an event subject, an event location, an event object an event object location, and a list of event attributes), and a plurality of subsessions, each with its own header information and lists of events.

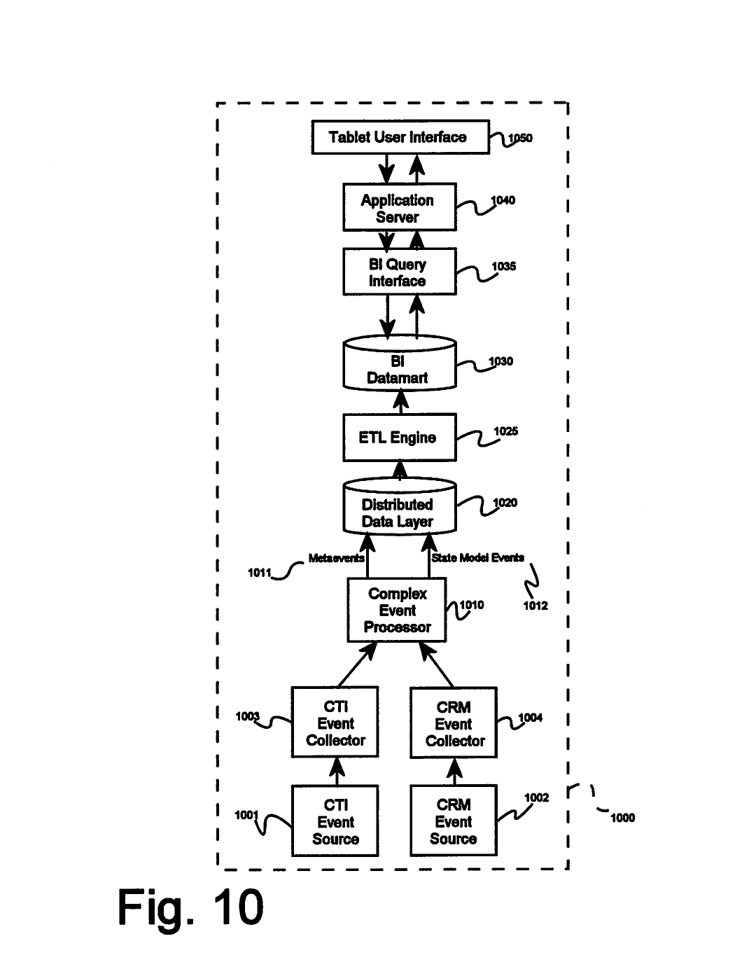

FIG. 10 is a block diagram of an embodiment of the invention, highlighting aspects of a business intelligence stack or business analytics software module 1000. Business analytics software module 1000 may be distributed across multiple physical and virtual machines which are in turn distributed among various physical locations (e.g., data centers), which may be owned and operated by different entities (typically event sources and user interfaces are owned by a client entity and the other elements comprising stack 1000 are owned by a service provider, although they could be provided by a plurality of cooperating service providers). As described in some detail above, everything starts with event sources, such as CTI event source 1001 and CRM (customer relationship management) event source 1002. Event sources 1001, 1002 pass events “up the stack” via event collectors such as CTI event collector 1003 and CRM event collector 1004, as described previously with reference to FIG. 2, and collected events are transformed by event collectors 1003, 1004 into one or more standard formats recognized by one or more complex event processors 1010. As discussed with reference to FIG. 2, a plurality of complex event processors 1010 receive events, in one or more standard formats or protocols, from a variety of event collectors 1003, 1004, and process these events as described with reference to FIG. 4, producing metaevents 1011 and state model events 1012 that are then passed into distributed data layer 1020 (note that, as mentioned above, raw events may also be passed through complex event processor 1010 and into distributed data storage layer 1020 in addition to, or instead of, metaevents or state model events, in some embodiments. Business analytics software module or business intelligence stack 1000 further comprises, in a preferred embodiment, one or more software modules (or dedicated hardware appliance) that extract data from distributed data layer 1020, transform the extracted data to a form suitable for use in business intelligence (BI) systems (which are well understood in the art), and load the transformed data into a BI-ready data system such as BI datamart 1030. The process of extracting, transforming, and loading data from data layer 1020 to BI datamart 1030 is carried out by ETL (ETL=“Extract, Transfer, and Load”) engine 1025. Many varieties of ETL engines 1025 are known in the art of business intelligence platforms, any of which may be used according to the invention. Similarly, while BI datamart 1030 is one form of BI-ready data storage system, others such as data warehouses and “data universes” are well known in the art of BI platforms, and any of these may be substituted for BI datamart 1030 without departing from the scope of the invention. Normally, data is stored in BI systems such as BI datamart 1030 in a form that is optimized for reading (whereas often distributed data layer 1020 may be optimized for continuous writing), and often data is stored in “human-friendly” form. For example, when a computer software program is intended to do extensive date range computations, it is often most suitable to represent a date time data element as a universal computer time (UCT) value, which corresponds to a number of seconds elapsed since Jan. 1, 1970, and which accordingly is always a single large unsigned integer (making it well suited for computer computations). On the other hand, humans find reports that have axes labeled with UCT values to be less than optimal, since few people will readily be able to associate a UCT value with a time-of-day or clock time, which is what humans run their lives by. Accordingly, usually (but not necessarily) time values in BI datamart 1030 are stored in separate fields for date, day of week, and time, and in human-readable formats, such as “Wednesday, May 21, 2011, 4:59 pm”. Similarly, a common transformation step carried out by ETL engine 1025 is to assemble prebuilt aggregates of data; for instance, in the contact center world, it is common to store data such as “calls received” in fifteen-minute intervals (i.e., “call received between 12:01:01 and 12:15:00”).

Data in BI datamart 1030 is generally accessed via one or more BI query interface tools 1035, generally provided by the vendor of the BI platform being used for BI datamart 1030 in a particular implementation. BI query interface 1035 typically exposes a number of prebuilt or preconfigured query templates for assembling user-ready data elements such as totals, counts, percentage shares, cumulative totals, moving averages, and the like. In many embodiments BI query interface 1035 is accessed by end users via an application server 1040, which acts as an intermediary between an end user and BI query interface 1035 (although in some embodiments users—typically what are known in the art as “power users”—access BI query interface 1035 directly, generally to perform ad hoc queries that tend to require iterative querying and query refinements). Application server 1035 generally handles security (user authentication, prevention of unauthorized access, data and query validation to prevent common threats such as SQL injection, and so forth), protocol conversion (many user interfaces are web-based and accessed via a browser or web-enabled tablet user interface 1050, and use web services protocol to access functionality of BI query interface 1035; it is a standard function of application servers to receive web services requests and to parse them, check their validity, and then pass them on to the software module—in this case BI query interface 1035—that will actually carry out the requested services). Tablet user interface 1050 is an exemplary user interface element, according to a preferred embodiment of the invention, although it will be understood by one having ordinary skill in the art of BI interfaces that a browser-based interface, a “thick client” interface, or indeed any other available interface modality known in the art, may be used instead of or in addition to tablet user interface 1050. It can be seen that use of BI stack 1000 allows events to flow from their sources 1001, 1002, through a series of successive refinement stages, to a user-friendly user interface 1050 that presents rich statistical information (generally in either graphical form or tabular form, or often in both) to allow users to probe the behavior and monitor the operations of complex systems that emit events as they operate.

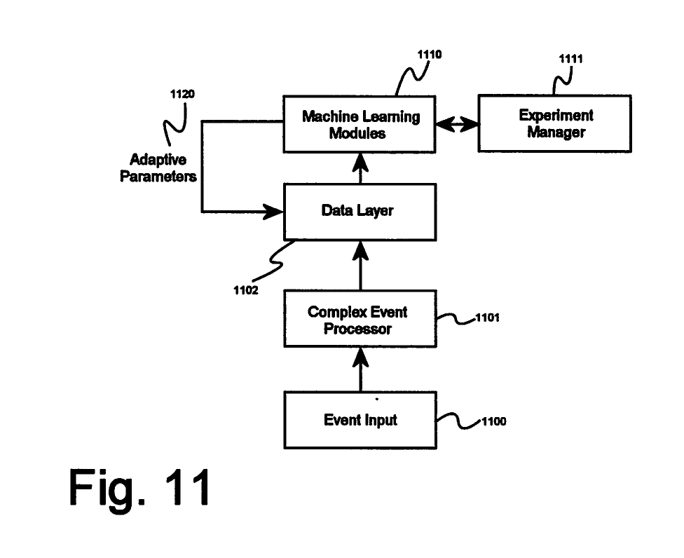

FIG. 11 is a block diagram of an embodiment of the invention, highlighting aspects of a machine learning stack. As before, events are received via event input means 1100 (the first three layers of FIG. 11 are intentionally simplified as they have already been discussed in detail above, with reference to FIGS. 2-9), and passed to a complex event processor 1101 and thence on to a data layer 1102. As disclosed in several embodiments previous presented, there are many possible architectures according to which event input 1100, complex event processor 1101, and data layer 1102 can be implemented, any of which may be used according to the invention. Machine learning modules 1110 retrieve or are fed data from data layer 1102 in order to learn from the data—hence machine learning. “Learning” often refers to detection of one or more patterns in a set of data; often, data is subdivided into a training set and a test set in order to facilitate machine-based learning techniques. A training set is fed into one or more pattern-finding algorithms to generate one or more patterns thought to be representative of a structure of the larger data set from which the training set was drawn. Patterns can be used to predict outcomes of experiments, or to predict one or more attributes that a subsequent data set will be, when an initial data set is fed into algorithms generated as a result of the patterns. For example, a after running a training set through a machine learning module 1110, a set of patterns might be deduced and expressed in terms of a set of adaptive parameters 1120. Then, using these parameters to “tune” a prediction algorithm, an initial subset of a data test set is passed through the prediction algorithm, and a predicted set of attributes for a likely subsequent data set is generated. This predicted subsequent data set is then compared to the actual subsequent data set (which is taken from the balance of the test set), and one or more quantitative or qualitative assessments of the adequacy of the prediction algorithm that uses adaptive parameters 1120 is generated. In some embodiments, machine learning 1110 modules operate iteratively, continuously or periodically extracting from incoming data training and test sets and using these to generate and evaluate sets of adaptive parameters 1120. Either continuously or after a required level of forecast accuracy is achieved, adaptive parameters 1120 may be used to make predictions based on sets of incoming data retrieved from data layer 1102, and in some embodiments adaptive parameters 1120 are fed back into data layer 1102 as shown in FIG. 11. Such “fed back” adaptive parameters 1120 may be used to predict or indeed to control underlying processes from which data used to generate them was acquired. There are many well established machine learning algorithms known in the art, including but not limited to various forms of neural networks, genetic algorithms, K-clustering and other cluster-based algorithms, tabu searching, simulated annealing, and so forth. Any of these may be used in one or more machine learning modules 1110 according to the invention. In some embodiments, two or more machine learning modules 1110 may be run competitively; that is, each machine learning module 1110 attempts to learn from a given data stream, and adaptive parameters 1120 from each module are compared against those emanating from each other module to determine which is exhibits most fitness or accuracy. In some cases, fitness ratings from different machine learning modules 1110 may vary relative to one another according to differing conditions pertaining in an underlying real system from which the data emanates (via data layer 1102); identifying which machine learning module 1110 gives best results for given operating conditions is one of the goals of machine learning modules 1110. In some embodiments, machine learning modules 1110 operate with little or no human interaction, acting on data streams pulled from data layer 1102 and sending adaptive parameters back to data layer 1102 under control of configuration settings maintained in configuration 250. In other embodiments, experiment manager 1111 provides a user interface that allows a human user or operator to interact directly with machine learning modules 1110. Operators may perform different tasks related to directing machine learning modules 1110, including but not limited to specifying data sets, specifying particular machine learning algorithms to use or to avoid (or adjusting relative weights accorded to results from a plurality of algorithms when determining adaptive parameters 1120). An exemplary interaction involving experiment manager involves a user's selection, from many possible variables to consider, a particular set of variables to analyze for undetected patterns; in complex systems characterized by extremely high dimensionality, even well-tuned machine learning algorithms will often deliver useless results unless they are focused on appropriate sets of variables. For example, in one embodiment machine learning modules 1110 analyze data regarding agent skill assignments, call types, and handle times to determine if some agents are preferentially more productive at some call types than at others.

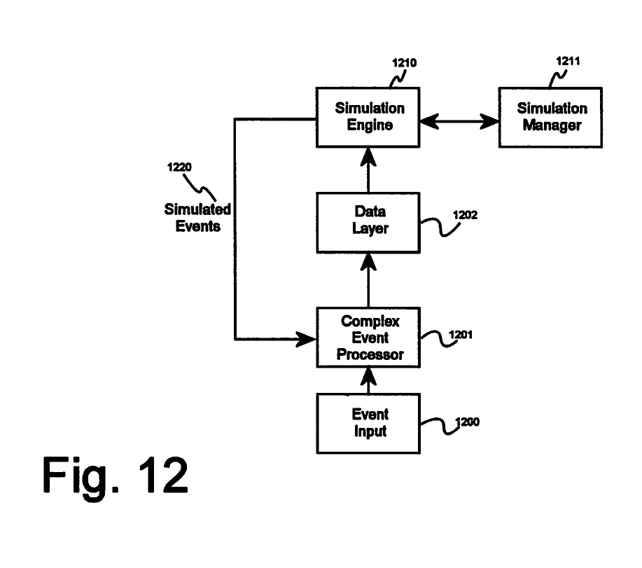

While machine learning algorithms may in some cases be successful in identifying patterns that may be suitable for leveraging (typically by adjusting operating parameters of center 100), they may not always be able to predict the effects of a variety of possible configuration changes that might be made based on adaptive parameters 1120. This is typically because machine learning modules 1110 will usually consider only small sets of variables in isolation when examining data sets from data layer 1102 (to keep problems tractable for machine learning analysis), while overall operation of centers 100, 101 depends on many variables and cannot be predicted by considering only a few of them. Accordingly, it is often desirable to take advantage of advanced simulation experiments to attempt to understand likely overall system behavior in the presence of anticipated changes. FIG. 12 is a block diagram of an embodiment of the invention, highlighting aspects of a simulation stack with dynamic simulation model development. Again, complex event processor 1201 processes events from event input 1200 and results are stored in data layer 1202. Data may be extracted from data layer 1202 continuously, periodically in batch mode, or on demand from simulation manager 1211, by simulation engine 1210. Simulation engine 1210 is adapted to conduct simulations of complex system operations using one or more well established simulation techniques known in the art, including but not limited to discrete event simulation, analytical simulation using systems of differential equations, or agent-based simulation. It will be appreciated by one having ordinary skill in the art of simulating complex systems that there are many advanced techniques of simulation that are available in the art, any of which may be used according to the invention without departing from the scope of the invention.

In a preferred embodiment of the invention, simulation engine 1210 carries out one or more simulation experiments to model expected behaviors of a contact center when responding to or initiating customer interactions. According to the embodiment, simulation models are developed at least in part based on actual operating statistics obtained from data layer 1202, such as a plurality of statistical parameters characterizing various agents' actual handle times for various types of interactions, the statistical parameters comprising at least one or more of an average value, a standard deviation, or set of parameters providing a polynomial fit of the agents' handle time behaviors for each call type of interest. For instance, observation over a period of time of an agent's handle times for sales calls to premium customers may be used to generate an average and a standard deviation of handle time, as well as a polynomial fit for a curve that plots number of calls against time; in some cases, it has been observed that sales agents' distribution of handle times obeys an unusual bimodal statistical distribution (that is, one consisting of two superimposed “bell curves”), such that an average handle time may not accurately reflect the agent's likely performance on sales calls. According to a preferred embodiment, statistical models of agents, call types or customers, and other “actors” in contact center operations may be estimated automatically from historical or real time statistical data obtained through observation of those actors' actual performance. Optionally, machine learning modules 1110 may be used to advantageously assemble statistical models of behaviors of actors in a contact center, either automatically or semiautomatically (automated machine learning with occasional or intermittent human interaction generally through experiment manager 1111). Additionally, simulation manager 1211 may be used in a mode similar to that described above for experiment manager 1111 (in some embodiments, experiment manager 1111 and simulation manager 1211 may be incorporated in a single executable software application or code module). According to an embodiment, when simulation engine 1210 runs simulation experiments, it may pass some or all resulting simulated events 1220 directly to complex event processor 1201, which may instantiate a set of simulation state machines corresponding to “real” objects and use simulated events 1220 to track state changes of the corresponding simulated objects. In this way, reporting or BI tools operating on data in data layer 1202 that usually provide reporting and analytics pertaining to “real world” operations of the complex system related to event input 1200 may be used to report on and analyze results of one or more simulation experiments. This process of simulating using statistical behaviors determined from real objects, but with potentially different business rules put in place (for instance, different routing strategies) allows users to perform “what if” analyses of contemplated new business rules. It can also be used, with the same rules as are used in the real system, to model the real system's response to hypothetical operating conditions. For example, a user might want to model what would happen to service quality if a contact center 100 were forced to handle 10% more traffic than forecasted, or if the mix of different interaction types was significantly different from historical norms or forecasted values.

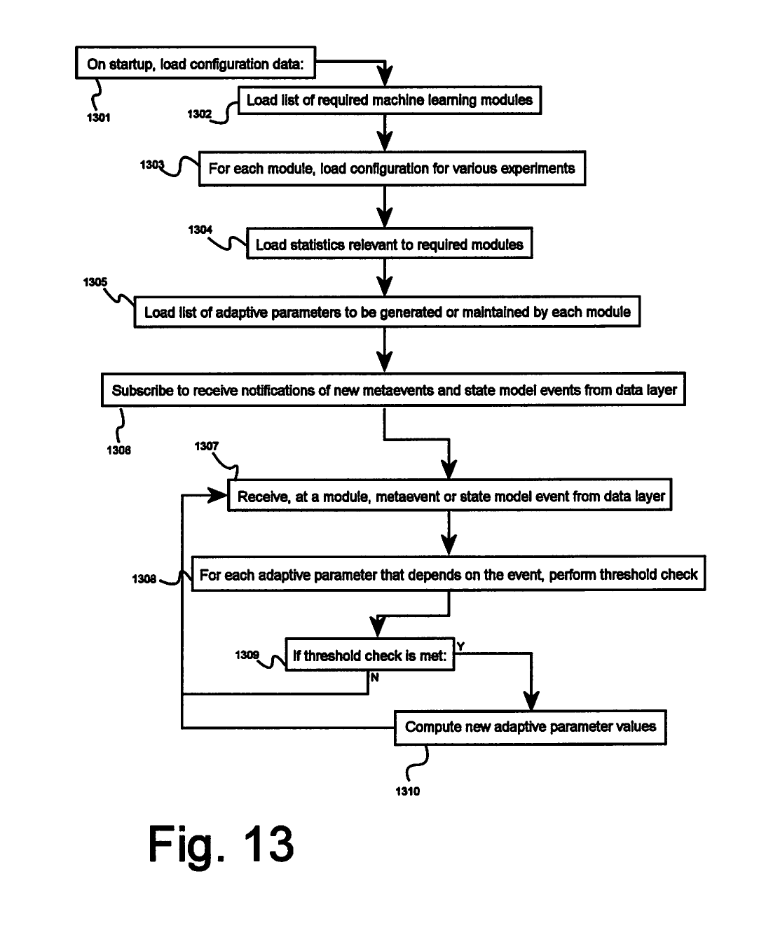

FIG. 13 is a process flow diagram illustrating a process according to an embodiment of the invention in which machine learning is used to adapt a complex customer care process. In step 1301, on startup of a system according to the invention, configuration data is loaded from distributed configuration subsystem 250. Configuration data that is loaded in step 1301 generally includes information analogous to that which can be input or changed using experiment manager 1111 including, but not limited to, connection information pertaining to distributed data layer 1102, information about objects to be analyzed, and so forth. More particularly, in step 1302 one or more lists of required machine learning modules is loaded. Dynamic loading on startup is typically used so that new machine learning modules may be added to the system at any time via experiment manager 1111 or directly via distributed configuration interface 250. In step 1303, for each module loaded in step 1302, configuration data pertaining to particular experiments to be carried out by each module is loaded from configuration subsystem 250. Then, in step 1304, for each module (and for each experiment to be used by each module), a set of statistics relevant to the modules or the experiments may be loaded from configuration subsystem 250; generally machine learning modules 1110 will thereupon connect to one or more complex event processors 1101 and register to receive updates of the values of the relevant statistics. In step 1305 one or more lists of adaptive parameters 1120 to be generated or maintained by machine learning modules 1110 are loaded by machine learning modules 1110. Adaptive parameters 1120 are parameters which may be used to control behavior of a complex system such as contact center 100, or which may be used to present information about such behavior to human or machine users, the information being adapted to enable informed decision-making by those users to improve the behaviors (improve generally taken to mean “improve in terms of goals of the users”). Adaptive parameters 1120 are referred to as such because they may be adapted through use of machine learning modules 1110 to deliver improved performance of a complex system against one or more goals established by users or stored in configuration subsystem 250. In step 1306, machine learning modules 1110 subscribe to the plurality of statistics determined in step 1304, the subscriptions being made with each complex event processor 1101 responsible for generating one or more of the statistics.

In an exemplary embodiment of the invention, steps 1307 through 1310 outline a process for adaptation of adaptive parameters 1120, although this process is merely one of many possible adaptation processes which may be used according to the invention. It will be recognized by one having ordinary skill in the art of adaptive systems design that there are a wide range of adaptation processes known in the art, any of which may be used by machine learning modules 1110 according to the invention. In step 1307, one or more machine learning modules 1110 receives a metaevent or state model event from data layer 1102. For each adaptive parameter 1120 that depends on (or is in any way influenced by) the event received, in step 1308 a threshold check is performed. Examples of threshold checks may include, but are not limited to, determining whether a statistic that is modified as a result of the event exceeds, in its modified form, a minimum or maximum value, or exhibits a degree of change that exceeds a specified change threshold. Again, it should be clear to one having ordinary skill in the art that not only are there many kinds of thresholds that may be used in step 1308 according to the invention, but also that other types of tests than simple threshold tests can be substituted for the threshold test of step 1308 without departing from the scope of the invention. In step 1309, the result of the threshold (or other applicable) test is checked. If the threshold test was satisfied or the threshold check was met, in step 1310 a new set of adaptive parameter 1120 values is computed in which each affected adaptive parameter 1120 is given a new value (which in accordance with FIG. 11 is then passed to data layer 1102) and execution then loops back to step 1307 and machine learning modules 1110 await a new event; otherwise, execution loops directly back to step 1107.

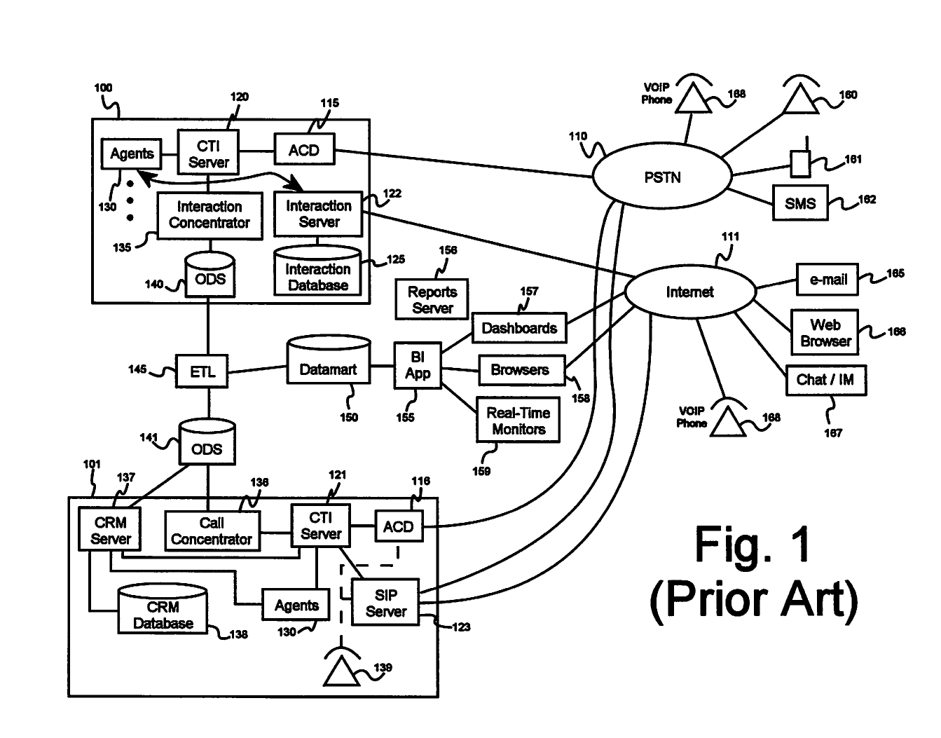

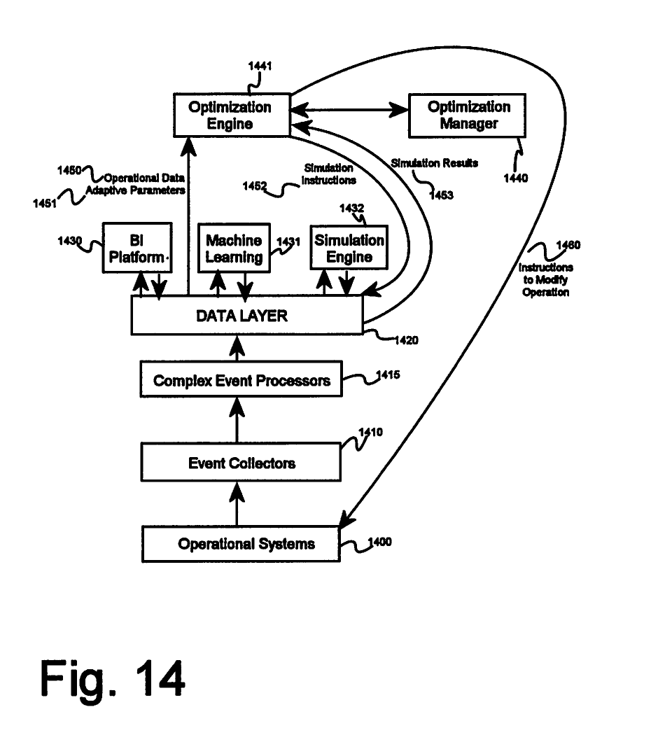

The process just outlined is an example of a more general optimization process that may be carried out according to the invention. Optimization refers to making changes to one or more control parameters in order to achieve some optimal distribution of measurements regarding operation of a complex system such as contact center 100. Optimization is a well-established applied mathematics discipline, according to the principles of which many techniques are known in the art that may be used to carry out intended optimizations. FIG. 14 is a block diagram of an embodiment of the invention, highlighting aspects of an optimization stack intended to carry out a wide range of optimizations according to the needs of users of a complex system. Operational systems 1400 carry out the operations of a complex process, thereby emitting events that are passed to event collectors 1410. Operational systems may comprise, for example, components of call center 100 and contact center 101 shown in FIG. 1, although any set of systems collectively comprising a complex system can be used as a source of events to event collectors 1410 according to the invention. As described above, events are passed from event collectors 1410 to complex event processors 1415, and after processing a stream of metaevents, state model events, and raw events are passed into data layer 1420. As described in more details with respect to FIGS. 10, 11, and 13, various types of data are passed between data layer 1420 and BI platform 1430, machine learning modules 1431, and simulation engine 1432. Additionally, operational data 1450 and adaptive parameters 1451 may be passed from data layer 1420 to optimization engine 1441. Optimization engine 1441 also optionally exchanges information with simulation engine 1422, passing simulation instructions 1452 to simulation engine 1422 and receiving simulation results 1453 back from simulation engine. Optimization engine sends, as output, instructions 1460 to modify operation of a complex system composed of operational systems 1400. Optimization engine 1440 may be controlled by configuration data stored in configuration subsystem 250 or directly by a user using optimization manager 1440.

Optimization engine 1441 is a software module executing on a server, including possibly a virtual server instance running on a general purpose computer, that carries out a plurality of optimization routines using input data (that is, data such as operational data 1450, adaptive parameters 1451, and simulation results 1453 obtained as a result of simulation engine 1432 running a plurality of simulation experiments according to simulation instructions 1452), the optimization routines generating output data that are used as instructions 1460 to operational systems 1400, all in order to optimize the operation of a complex system comprising operational systems 1400 according to a plurality of goals or objective functions. Optimization routines may be any suitable optimization algorithms, including but not limited to constraint-based optimization, linear and non-linear and dynamic programming, genetic algorithms, neural networks, tabu search, ant colony optimization, or any other analytically rigorous or heuristically derived optimization routine. It will be appreciated by one having ordinary skill in the art of optimizing complex dynamic systems that there exists a wide range of potentially suitable optimization routines, some of which may be more or less suited for particular optimization problems, and any of which may be used in optimization engine 1441 without departing from the scope of the invention.

As an example of a possible use of an optimization stack such as that shown in FIG. 14, a call center 100 may have a large number of agents trained to respond to customer inquiries. Some of the agents may be qualified to handle more than one type of customer inquiry, for example loan sales, credit card sales, or general inquiries (many other skill types may be used, including language spoken by a customer, customer segment, agent experience level, etc.), while other agents may only handle a single type of inquiry. In some embodiments, agents are assigned skill levels, for example on a scale from 0 to 10, for each skill they might possess. It is commonplace in call centers 100 (and contact centers 101 as well) for agents to be assigned certain skills and skill levels following initial training based for example on test scores. According to an exemplary embodiment, as calls arrive in call center 100, they are handled by various operational systems 1400 (such as ACD 115, CTI server 120, and so forth). The handling of customer inquiries within operational systems causes events to be generated such as “EventRinging”, “EventEstablished”, “EventReleased”, and so forth; events are passed to event collectors 1410 and thence onward to complex event processors 1415. Ultimately these events result, according to processes already described herein, in generation of operational data 1450 and adaptive parameters 1451, which are passed to optimization engine 1441. Optimization engine may determine that certain agents are better suited to handle calls of one skill type in preference to those of another skill type, while other agents will exhibit other patterns. At the same time, optimization engine 1441 may generate or receive some estimate of current demand for each call type, or may generate a forecast of upcoming demand for each call type or demand for each skill type. With these exemplary inputs in hand, optimization engine 1441 may then be able to determine an optimal routing logic that delivers calls to particular agents in such a way that an overall fitness level or objective function (such as for example sales made, customer satisfaction levels, average handle times, and so forth), or a plurality of such fitness levels or objective functions, is maximized over the entire call center 100. In many cases, however, it may not be possible to positively determine an optimal routing approach, or an optimal assignment approach for each agent, given a set of input parameters (those having ordinary skill in the art of optimization of complex systems will recognize that this is actually quite common). In some of these cases, it may be advantageous according to the invention to run a series of simulation experiments with different possible settings of adaptive parameters 1451, and accordingly simulation instructions 1452 are sent to simulation engine 1432 via data layer 1420 (although they could be sent directly to simulation engine 1432) to direct such experiments. When results 1453 from those experiments are received back form simulation engine 1432 (again, either indirectly from data layer 1420 as shown, or directly from simulation engine 1432), optimization engine may in response adjust instructions 1460 to operational systems 1400.

To put this all together into a single example, consider a call center 100 as described above, with a plurality of multiskilled agents handling inbound customer interactions. Certain employees of call center 100 are generally responsible for managing operations and maintaining overall service quality and productivity, attempting to reconcile the often conflicting goals of delighting customers and meeting budgetary targets. These employees will typically use BI platform 1430 to monitor ongoing operations and to examine past operations in order to understand what factors drive performance. In addition, machine learning modules 1431 may be focused on analysis of certain combinations of operational parameters, for instance the distribution of skills and the accuracy with which administrative skill assignments reflect actual skill demonstrated by the agents. Machine learning modules 1431 might determine, for example, that not only do many agents' assigned skills not accurately reflect their actual skills, but that the distribution of calls may be suboptimal in that calls are often sent to agents with lesser actual or effective skill levels in the applicable skills for the calls, particularly if other agents could have been used who had better skills but weren't so used. This may happen, for example, when calls are distributed according to a routing rule that says “route each call to the longest waiting agent who has at least a minimum level of any required skills”. An agent satisfying this rule might not be the optimal agent; there could be another agent available who is better qualified but hasn't been waiting as long for a call. According to an exemplary embodiment, machine learning modules 1431 use various machine learning algorithms to generate a series of recommendations such as changes in skill levels, removal of some skill assignments, and changes in routing rules to more optimally distribute calls. Such recommendations may be sent to optimization engine 1441, which may display the recommendations to an employee using optimization manager 1440. However, since call center 100 is a complex system, it would be risky for the employees to simply implement all of the recommendations from machine learning modules 1431; even if such confidence in “the machine” were reasonable, it will usually be the case that machine learning modules 1431 will develop recommendations using only a subset of available operational data parameters 1450, since attempting to use all available parameters leads to intractable problems of overly high dimensionality. Accordingly, an employee may, using optimization manager 1440, direct optimization engine 1441 to conduct simulation experiments to determine expected overall results likely to be achieved by implementing the recommendations, and to iteratively adapt the recommendations to achieve an optimal result. Such instructions may include limits passed to optimization engine 1441, such as a limit to how many simulation experiments may be run (to prevent inadvertently launching optimization engine 1441 and simulation engine 1422 into an “infinite loop” that operates indefinitely without delivering a final answer), or a minimum overall productivity gain to achieve before putting a series of adapted recommendations into effect (this recognizes the well-known fact that, in optimization problems, it is often hard to know if a certain solution is the best possible solution, whereas it is generally not difficult to know if a certain solution is a “good enough” solution that should be implemented). On receiving such instructions from the employee, optimization engine 1441 sends instructions 1452 to simulation engine 1432 directing it to perform required simulation experiments (note that in some embodiments an employee might directly interact with simulation engine 1422 using simulation manager 1211). When simulation results are determined according to rules sent in instructions 1452, simulation results 1453 are returned to optimization engine 1441, which may then optionally ignore the results, send more instructions to conduct more simulations, ask for operator review and confirmation, or directly implement recommendations based on the simulation results by sending operating instructions 1460 to operational systems 1400. Note that the system described here and illustrated in FIG. 14 may operate in a closed-loop fashion; when changes are implemented as just described, event streams are monitored via event collectors 1410 and complex event processors 1415 to verify that the changes made did have the desired effects on overall complex system performance, and that no (or no substantial) adverse effects are observed. By monitoring operational results following each change, a means of iteratively optimizing performance of a complex system under control of optimization engine 1441 is provided.

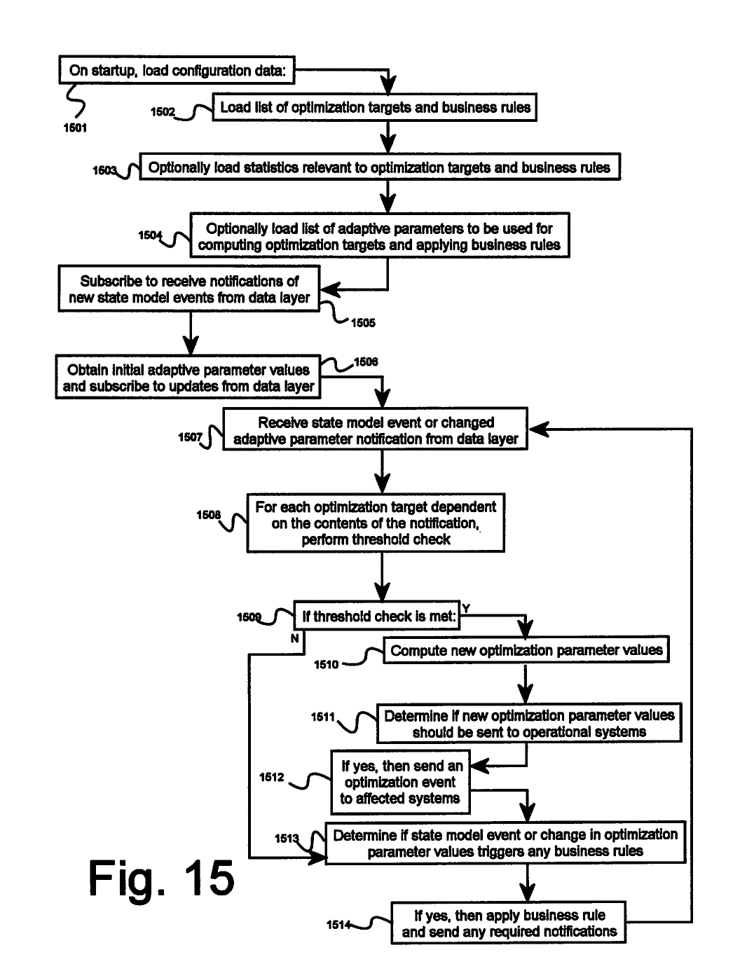

FIG. 15 is a process flow diagram illustrating a process according to an embodiment of the invention in which an optimization stack is used to optimize a complex customer care process. Like all similar processes already described, an initial series of steps initializes the process; any of these steps may be repeated (also true for each of the previous cases) periodically or on demand to “refresh” the operating environment in which the process takes place with new configuration data. Accordingly, in step 1501 optimization engine 1441 loads configuration data on startup. In step 1502, optimization engine 1441 loads one or more lists of optimization targets and business rules that will govern its efforts to optimize one or more aspects of a complex process. In step 1503, optimization engine 1441 may optionally load one or more statistics relevant to the optimization targets and business rules loaded in step 1502, and in step 1504 it may load one or more lists of adaptive parameters to be used for computing whether optimization targets are being met or in applying business rules. In step 1505 and 1506, optimization engine 1441 subscribes to receive notifications of new state model events and statistics from data layer 1420 and obtains initial adaptive parameter values, respectively. Optimization engine 1441 may also, in step 1506, subscribe to receive updates from data layer 1420 or machine learning modules 1431 when one or more adaptive parameters change their values (for example, every time they change, or periodically, or when they change by more than some threshold amount). After steps 1501-1506 optimization engine is initialized (and set up to remain synchronized with configuration data), and in step 1507 optimization engine 1441 waits for and then receives a state model event or changed adaptive parameter notification from data layer 1420. In some embodiments, optimization engine 1441 may also receive raw events (events essentially as they were processed by event collectors 1410) or metaevents processed by complex event processors 1415. Step 1507 is the first step in an exemplary event-processing loop (note that “adaptive parameter change notification” is in effect another type of “event”, as the term is commonly understood by one having ordinary skill in the art of computer programming), the loop comprising steps 1507 through 1514, and looping repeatedly back from step 1514 to step 1507 until interrupted (such as by shutting down optimization engine 1441). After receiving an event in step 1507, in step 1508 optimization engine 1441 evaluates, for one or more optimization target dependent or potentially dependent on the event received, or for all optimization targets, whether the event signals a change in the optimization parameter, and whether that change satisfies some threshold condition (keeping in mind that “threshold” is only an exemplary test; other types of checks could be performed as well, such as whether a predetermined amount of time has occurred since the last update of the affected optimization parameters, without departing from the scope of the invention). In step 1509, the results of the threshold or other test performed in step 1508 is evaluated; if the test or check failed, the process jumps to step 1513; otherwise it moves to step 1510. In step 1510, for each optimization parameter for which the threshold check was satisfied, a new value is computed, generally (but not necessarily) based at least in part on the contents of the event processed in step 1507). Then, in step 1511, a check is made to determine whether the newly modified optimization parameters should be sent via an event notification to any affected systems. In some embodiments, notifications might not be sent when changes determined in step 1510 are too small to make a difference in the functioning of the complex system; in other embodiments, all updates to optimization parameters are passed along; while in yet other embodiments updated parameters are only passed along to operational systems 1400 periodically, for instance every five minutes, and in these embodiments a check would be made in step 1511 to see if enough time has passed since the last update. In step 1512, if an update of one or more optimization parameters is required, then an “optimization event” is sent to any affected systems. Affected systems might be operational systems 1400, or they might be simulation engine 1432, machine learning modules 1431, or any other module which requires periodic or change-based notifications of optimization parameters (for instance, optimization manager 1440 would typically have a view displaying all changes as they occur). In step 1513, a check may be made to see if an event being processed, or any optimization event representing a change in one or more optimization parameters, triggers any business rules. As mentioned before, business rules can be stored in data layer 1420 and processed in optimization engine 1441. When an iteration of event processing loop 1507-1514 gets to step 1513, the events being evaluated are compared to each business rule to see if any rule is triggered (that is, to determine whether a condition that is a component of a rule is satisfied by one or more of the events being evaluated in step 1513). In some embodiments, each business rule may be indexed or classified based on a set of events which may trigger it, so that only those rules that might be triggered by a given event need to have their conditions checked (those rules for which the specific event type being evaluated is not designated as an event that might trigger the rule are simply ignored for efficiency); in other embodiments, every rule might be evaluated. Other rule-filtering procedures may be used as well; for instance, some rules may have conditions based on the states of objects of a certain type; if an event being processed does not affect any objects of that type, that rule could safely be skipped. If a business rule is triggered in step 1513, the actions specified by that rule are carried out in step 1514, either directly in optimization engine 1441 or in an appropriate system, the system receiving a notification event from optimization engine 1441 advising it of the triggering of a rule that requires it to take some action. After carrying out any required actions and sending any required notifications in step 1514, optimization engine 1441 returns to step 1507 and awaits further events for processing in event loop 1507-1514.

The skilled person will be aware of a range of possible modifications of the various embodiments described above. Accordingly, the present invention is defined by the claims and their equivalents.

1. A system for conducting real-time analysis of complex customer care processes, the system comprising:
an event collector software module operating on a network-attached computer and adapted to receive events in real time from a plurality of event sources;
a complex event processing software module operating on a network-attached computer located remotely from the contact center associated with the enterprise and operated by a network service provider independent of the enterprise and adapted to receive real-time events from the event collector software module;
a network-attached distributed data storage layer;
a business analytics software module operating on a network-attached computer and adapted to receive and process data from the distributed data storage layer;
a distributed configuration software module operating on a network-attached computer; and
a user interface software module operating on a network-attached computer and adapted to receive analytics results from the business analytics software module;
wherein the event collector further comprises at least an interface adapted to receive events delivered via a packet-based data network and a module for converting events from a first event data protocol into a second event data protocol;
wherein the complex event processing software module comprises an event queue adapted to buffer incoming events from the event collector software module and the complex event processing software module is further adapted to maintain a state machine based at least in part on a plurality of related events received via the event queue;
wherein the complex event processor carries out a process comprising the steps of:
(a) enqueuing incoming events in the event queue as they are received in real time from the event collector software module;
(b) dequeuing events from the event queue singly;
(c) passing the dequeued events to an event processor;
(d) processing the dequeued events in the event processor; and
(e) updating the state machine based at least on a result of step (d); and
wherein upon receiving an event from an event source, the event collector software module at least converts the event into a standard event data format suitable for use by the complex event processing software module and extracts or masks sensitive data from the event based on privacy rules maintained by the distributed configuration software module.

2. The system of claim 1, wherein the event collector further comprises at least an interface adapted to receive events delivered via a packet-based data network and a module for converting events from a first event data protocol into a second event data protocol.

3. The system of claim 1, wherein the processing of the event is carried out at least in part based on an event-processing rule maintained by the distributed configuration software module.

4. The system of claim 1, wherein the complex event processing software module maintains a state machine for each object for which events may be received from the event collector; and further wherein, upon receiving an event from the event collector, the complex event processing software module changes the state machine for objects affected by the event based on the event.

5. The system of claim 1, wherein the business analytics software module is a business intelligence platform comprising at least a module for extraction, transformation, and loading of data from the distributed data storage layer, and wherein the business intelligence platform further comprises a datamart, a query interface, and an application server adapted to wirelessly receive query requests from a plurality of tablet-based user interface devices.

6. The system of claim 5, wherein the business analytics software module further comprises a plurality of machine learning modules adapted to generate actionable recommendations based on automated analysis of data in the distributed data storage system.

7. The system of claim 1, wherein the business analytics software module is a discrete event simulation software module coupled to and controlled by a simulation manager user interface; and wherein the simulation software module performs a discrete event simulation of the operation of a real system, the real system being at least one of the sources of the events received by the event collector.

8. The system of claim 7, wherein upon performance of a simulation of the operation of the real system, simulated events generated by the simulation are passed to the complex event processing software module.

9. The system of claim 1, wherein the business analytics software module is an optimization engine software module coupled to and controlled by an optimization manager user interface; wherein the optimization engine module performs at least one optimization computation based on data derived at least in part from a plurality of events received by the event collector, and wherein at least one operational parameter used by a system from which events were received by the event collector is adjusted based on the at least one optimization computation.

10. A method for conducting real-time and historical analysis of complex customer care processes, the method comprising the steps of:
(a) receiving a plurality of events at an event collector software module operating on a network-attached computer, wherein the event collector further comprises at least an interface adapted to receive events delivered via a packet-based data network and a module for converting events from a first event data protocol into a second event data protocol;
(b) transforming the event using the event collector software module from a format in which it was received into a second event format;
(c) receiving real-time events in the second event format from the event collector at a complex event software module stored and operating on a network-attached computer;
wherein the complex event processing software module comprises an event queue adapted to buffer incoming events from the event collector software module and the complex event processing software module is further adapted to maintain a state machine based at least in part on a plurality of related events received via the event queue;
wherein the complex event processor carries out a process comprising the steps of:
(1) enqueuing incoming events in the event queue as they are received in real time from the event collector software module;
(2) dequeuing events from the event queue singly;
(3) passing the dequeued events to an event processor;
(4) processing the dequeued events in the event processor; and
(5) updating the state machine based at least on a result of step (d);
(d) based at least on the event received, passing state model events or metaevents from the complex event processing software module to a network-attached distributed data storage layer, the state model events based on changes in the state machines of the affected objects and the metaevents based on one or more previously received events or the received event; and
(e) using the state model events and metaevents in a business analytics software module operating on a network-attached computer.

11. The method of claim 10, further comprising the step of:
(g) extracting or masking sensitive data from the plurality of events according to privacy rules maintained by a configuration subsystem using the event collector software module.

12. The method of claim 10, wherein the business analytics software module is a business intelligence platform comprising at least a module for extraction, transformation, and loading of data from the distributed data storage layer, a datamart, a query interface, and an application server adapted to wirelessly receive query requests from a plurality of tablet-based user interface devices.

13. The method of claim 12, wherein the business analytics software module further comprises a plurality of machine learning modules adapted to generate actionable recommendations based on automated analysis of data in the distributed data storage system.

14. The method of claim 10, wherein the business analytics software module comprises a discrete event simulation software module coupled to and controlled by a simulation manager user interface; and comprising the further step of:
(g) performing a discrete event simulation using the simulation software module of the operation of a real system, the real system being at least one of the sources of the events received by the event collector.

15. The method of claim 14, further comprising the step of:
(h) passing simulated events generated by the simulation to the complex event processing software module.

16. The method of claim 10, wherein the business analytics software module is an optimization engine software module coupled to and controlled by an optimization manager user interface; and further comprising the steps of:
(g) performing at least one optimization computation based on data derived at least in part from a plurality of events received by the event collector; and
(h) adjusting at least one operational parameter used by a system from which events were received by the event collector based on the at least one optimization computation.
